(19) United States
(12) Patent Application Publication
(10) Pub. No.: US 2013/0317852 A1
(43) Pub. Date: Nov. 28, 2013

(54) MEDICAL DEVICE INFORMATION PORTAL

(71) Applicant: Geneva Healthcare, LLC, Minneapolis, MN (US)

(72) Inventors: Kai R. Worrell, Golden Valley, MN (US); Maria E. L. Petrina, Minneapolis, MN (US); Manish K. Wadhwa, San Diego, CA (US); GilAnthony D. Ungab, San Diego, CA (US)

(21) Appl. No.: 13/840,804

(22) Filed: Mar. 15, 2013

Related U.S. Application Data
(60) Provisional application No. 61/650,312, filed on May 22, 2012.

(51) Int. Cl. G06F 19/00

(52) U.S. Cl. CPC G06F 19/322
USPC 705/3; 705/2

(57) ABSTRACT

The medical device information portal provides a user-friendly platform for presentation of data obtained from device interrogation. The device data is presented in a uniform fashion irrespective of the device manufacturer. Further, the MDI Portal provides easy interpretation of interrogation findings from noticeable differences between normal and abnormal findings.

### CROSS-REFERENCE TO RELATED APPLICATION(S)

This application claims priority to U.S. Provisional Application No. 61/650,312, filed on May 22, 2012, and titled MEDICAL DEVICE INFORMATION (MDI) PORTAL, the disclosure of which is hereby incorporated by reference in its entirety.

### BACKGROUND

Implantable pacemakers and implantable cardioverter-defibrillators (ICDs) have been effectively utilized in the care of patients for several decades. Follow up of these implanted devices was limited to office-based, magnet-determined pacing rate modulation which indicated the remaining battery longevity. Current devices allow access to multiple critical data points reflecting device functionality and the patients overall clinical condition. The most recent advancements in device follow up have provided for easier access to device stored data by utilizing wireless connectivity and internet based access to data as a complement to information derived in point of care settings.

Evaluation and care of patients with implanted devices occurs in multiple inpatient and outpatient settings: hospital wards, the emergency department (ED) and Operating Room (OR), as well as, within private offices. While home monitoring of devices allows for device interrogation to be undertaken without the use of ancillary medical personnel, interrogation of devices within the point of care setting is usually done by ancillary medical personnel as the “interrogators” and thus is in fact dependent on the availability of these personnel. Availability to the personnel is a limitation which affects the efficient and timely delivery of healthcare to patients who warrant these services.

To further complicate matters, each device manufacturer has a proprietary software platform for programming and data presentation. The first task for ED staff and physicians is to identify the manufacturer of the implanted device in order to contact the appropriate ancillary medical personnel. Further, while device interrogation represents access to data, interpretation of this data requires an incremental level of expertise. ED staff and physicians themselves are not generally proficient in device interrogation and data interpretation.

### SUMMARY

In general terms, the present disclosure is directed to a medical device information portal for coordinating the exchange of information concerning a medical device (e.g., implantable pacemakers and automatic internal cardiodefibrillators) between a Health Information Exchange (HIE), a Device Vendor, and Device Vendor Dedicated Data Store. Various aspects are described in this disclosure, which include, but are not limited to, the following aspects.

One aspect of the Medical Device Information (MDI) Portal facilitates the exchange of information concerning a medical device (e.g., implantable pacemakers and automatic internal cardiodefibrillators) between a Health Information Exchange (HIE), a Device Vendor, and a Device Vendor Dedicated Data Store. The MDI Portal has an authentication engine configured to receive an authentication request from a HIE. The authentication engine analyzes the authentication request to determine whether to allow communication with the Health Information Exchange. The MDI Portal has a HIE communication engine to transmit and receive communications with the HIE and to receive patient and device information from the HIE relating to an implantable device. The patient and device information identifies a device vendor for the implantable device. The MDI Portal has an interrogation data engine to receive interrogation data relating to interrogation of a medical device. The MDI Portal has a device vendor communication engine for querying the device vendor regarding the patient and device information and configured to receive registry and device information from the device vendor. The MDI Portal has a user interface engine that presents the patient and device information from the HIE communication engine, the interrogation data from the interrogation data engine, and the registry and device information from the device vendor communication engine.

Another aspect is a medical device information portal comprising: at least one computing device including at least one processing device; and at least one computer readable storage device comprising data instructions, which when executed by the computing device cause the at least one computing device to generate: an authentication engine configured to receive an authentication request from a Health Information Exchange, the authentication engine analyzes the authentication request to determine whether to allow communication with the Health Information Exchange; a HIE communication engine to transmit and receive communication with the Health Information Exchange, the HIE communication engine is configured to receive patient and device information from the HIE relating to an implantable device, the patient and device information identifying a device vendor for the implantable device; an interrogation data engine to receive interrogation data relating to interrogation of a medical device; a device vendor communication engine for querying the device vendor regarding the patient and device information, the device vendor communication engine configured to receive registry and device information from the device vendor; and a user interface engine that presents the patient and device information from the HIE communication engine, the interrogation data from the interrogation data engine, and the registry and device information from the device vendor communication engine.

A further aspect is a medical device information portal comprising: at least one computing device including at least one processing device; and at least one computer readable storage device comprising data instructions, which when executed by the computing device cause the at least one computing device to generate: an authentication engine configured to receive an authentication request from a Health Information Exchange, the authentication engine analyzes the authentication request to determine whether to allow communication with the Health Information Exchange; a EMR communication engine to transmit and receive communication with the EMR System, the EMR communication engine is configured to receive patient and device information from the EMR System relating to an implantable device, the patient and device information identifying a device vendor for the implantable device; an interrogation data engine to receive interrogation data relating to interrogation of a medical device; a device vendor communication engine for querying the device vendor regarding the patient and device information, the device vendor communication engine configured to receive registry and device information from the device vendor; and a user interface engine that presents the patient and device information from the HIE communication engine, the interrogation data from the interrogation data engine, and the registry and device information from the device vendor communication engine.

Yet another aspect is a method of providing access to information relating to medical devices, the method comprising: receiving medical device information associated with a first medical device from a first medical device manufacturer; receiving medical device information associated with a second medical device from a second different medical device manufacturer; generating a first user interface to display the first medical device information; and generating a second user interface to display the second medical device information, wherein the second user interface is configured in a common format as the first user interface.

### BRIEF DESCRIPTION OF THE DRAWINGS

FIG. 1 is schematic block diagram illustrating an exemplary medical device information (MDI) portal.

FIG. 2 is a schematic of data communications for an exemplary MDI portal, shown in FIG. 1.

FIG. 3 is a schematic block diagram illustrating an example of the MDI portal, shown in FIG. 1.

FIG. 4 illustrates an exemplary architecture of a computing device.

FIG. 5 is a screenshot of an example patient search page of the MDI portal.

FIG. 6 is a screenshot of an example patient search results page of the MDI portal.

FIG. 7 is a screenshot of an example home page of the MDI portal.

FIG. 8 is a screenshot of an example page of the MDI portal.

FIG. 9 is a screenshot of an example page of the MDI portal.

FIG. 10 is a screenshot of an example page of the MDI portal.

FIG. 11 is a screenshot of an example page of the MDI portal.

FIG. 12 is a screenshot of an example page of the MDI portal.

FIG. 13 is a screenshot of an example page of the MDI portal.

FIG. 14 is a screenshot of an example page of the MDI portal.

FIG. 15 is a screenshot of an example page of the MDI portal.

FIG. 16 is a screenshot of an example page of the MDI portal.

FIG. 17 is a screenshot of an example page of the MDI portal.

FIG. 18 is a screenshot of another example of the MDI portal within an electronic medical records system.

FIG. 19 is a schematic of data communications with the MDI portal via one or more access points.

FIG. 20 is a screenshot of an example home page for a point of care provider.

FIG. 21 is a screenshot of an example consent agreement for a point of care provider to access the MDI portal.

FIG. 22 is an example table illustrating select alerts for modules in the MDI portal.

FIG. 23 is another example table illustrating select alerts for modules in the MDI portal.

FIG. 24 is a screenshot of an example page of the MDI portal.

FIG. 25 is a screenshot of an example page of the MDI portal.

FIG. 26 is a screenshot of an example page of the MDI portal.

FIG. 27 is a screenshot of an example page of the MDI portal.

FIG. 28 is a screenshot of an example page of the MDI portal.

FIG. 29 is a screenshot of an example page of the MDI portal.

FIG. 30 is a screenshot of an example page of the MDI portal.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

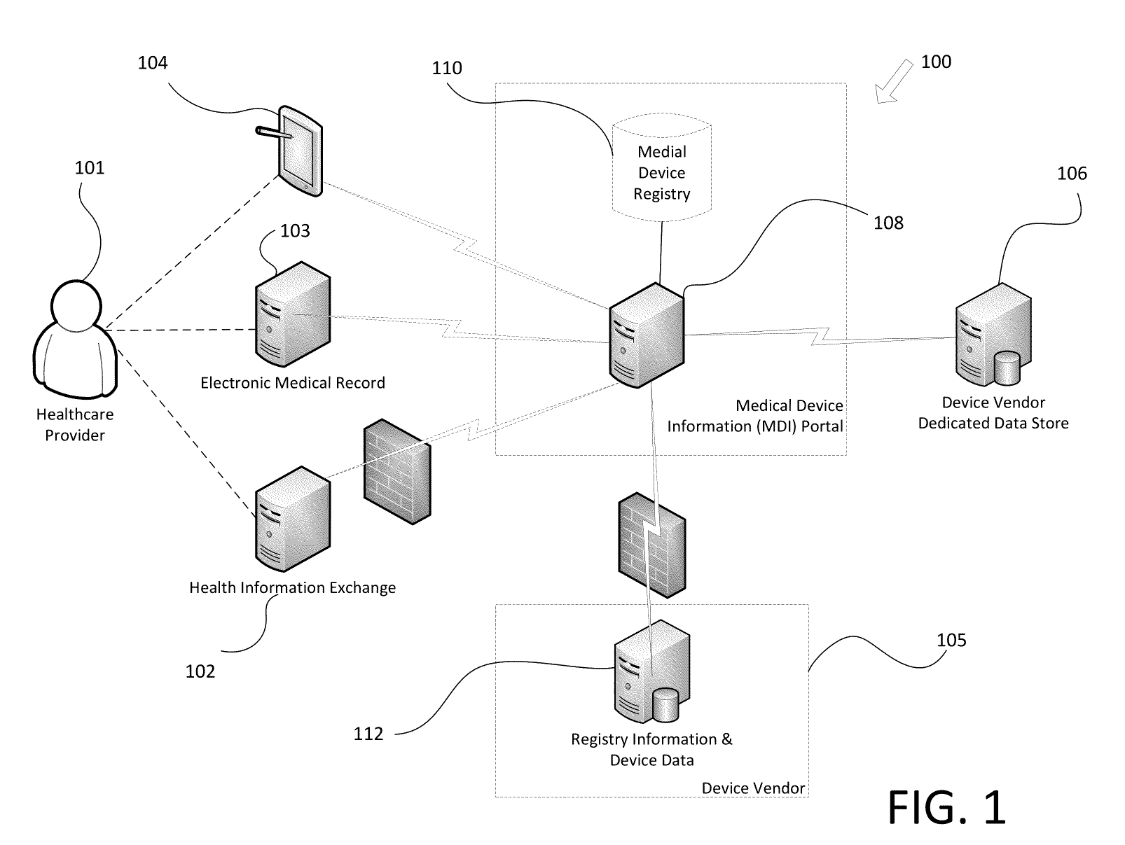

FIG. 1 is schematic block diagram illustrating an exemplary Medical Device Information (MDI) Portal 100. In the example embodiment, a healthcare provider 101 has several ways to communicate with the MDI Portal 100. As illustrated, the healthcare provider 101 may use a Health Information Exchange (HIE) 102, Electronic Medical Record (EMR) System 103, or a handheld computing device 104, such as a tablet pc to interact with the MDI Portal 100. By way of example, the MDI Portal 100 will be described below with respect to the HIE 102. To avoid undue repetition, this description of the MDI Portal 100 will not be separately repeated herein for each of the other EMR System and handheld computing device, including 103 and 104, but their implementation can also be configured as illustrated and described with reference to FIG. 1.

A MDI Portal 100 facilitates the exchange of information concerning a medical device (e.g., implantable pacemakers and automatic internal cardiodefibrillators) between a Health Information Exchange (HIE) 102, a Device Vendor 104, and a Device Vendor Dedicated Data Store 106.

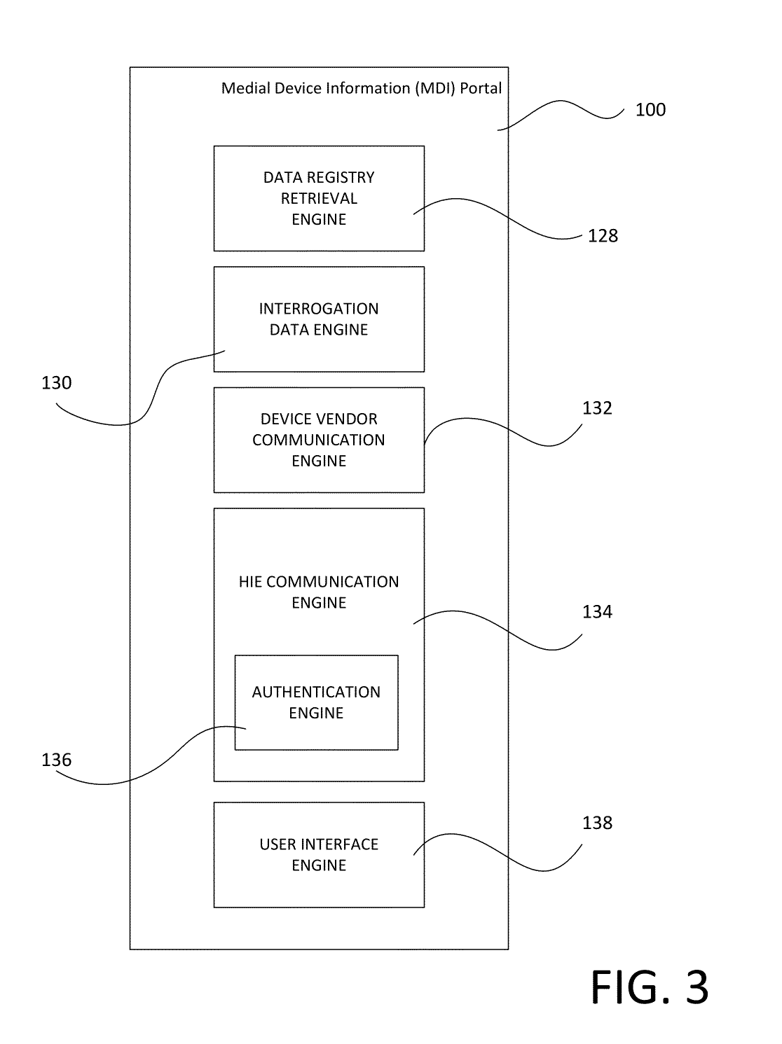

In the example MDI Portal 100, a computing device 108 is in data communication with the HIE 102, the Device Vendor 104, and the Device Vendor Dedicated Data Store 106. For example, the MDI Portal 100 may communicate over a wide area network (such as the Internet), a local area network, a cellular telephone network, a telephone system network, or other data communication network, in which data can be communicated with the HIE 102, the Device Vendor, and the Device Vendor Dedicated Data Store 106. Further, the communication between the MDI Portal 100 and the HIE 102, the Device Vendor 104, and the Device Vendor Dedicated Data Store 106, discussed in further detail with reference to FIG. 3, is configured to communicate in at least one of a variety of secure methods. It should also be noted that in some embodiments, the MDI Portal 100 further includes a Medical Device Registry 110 that contains a database of patients for all Device Vendors. The MDI Portal Medical Device Registry 110 associates each patient with their respective medical device and the particular Device Vendor 104.

Generally, the HIE 102 connects healthcare information systems such that physicians and health care providers can exchange information concerning their patients. The HIE 102 typically includes one or more computing devices in data communication with the MDI Portal 100. In the example embodiment, the MDI Portal 100 is configured to communicate with the HIE 102 to provide health care providers with data relating to a particular patient's medical device.

The Device Vendor 104 is the supplier of the medical device. The Device Vendor 104 includes a computing device 112 that maintains registry information and device data for their respective devices. Further, the Device Vendor 104 includes a Device Vendor Dedicated Data Store 106 that has information concerning each particular medical device. For example, in some embodiments, the Device Vendor Data Store 106 may include interrogation data from the device that occurred during the patient's last episode.

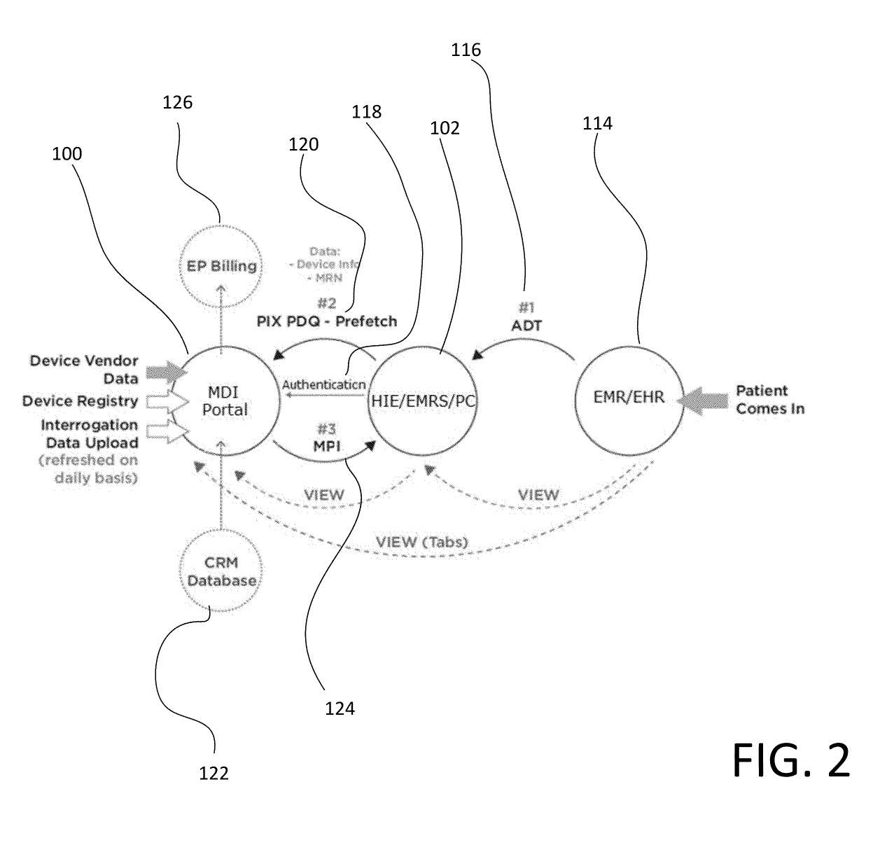

FIG. 2 is a schematic of data communications for the exemplary MDI Portal 100, shown in FIG. 1. The illustrated process begins when a patient enters a healthcare facility, which utilizes an electronic patient management system, and requires treatment. The healthcare facility creates an electronic entry on the patient's electronic medical record (EMR) or electronic health record (EHR) 114 to document the event. At that time, the healthcare provider will also determine whether the patient has an implanted medical device and issue orders for admission/discharge/transfer (ADT) for the patient.

By way of example, the MDI Portal 100 will be described below with respect to use of an HIE 102. To avoid undue repetition, this description of the MDI Portal 100 will not be separately repeated herein for each of the EMR System 103 and handheld computing device 104, but their implementation can also be configured as illustrated and described with reference to FIG. 2. But it should be recognized that the handheld computing device 104 would directly communicate with the MDI Portal 100.

The healthcare provider transmits the ADT orders 116 to the HIE 102. In addition to the ADT orders 116, the healthcare provider transmits patient information, including, for example, the patients name, their hospital identification number, etc., to the HIE 102. If the ADT orders 116 include orders related to the implantable medical device, the HIE 102 must first authenticate itself to the MDI Portal 100. Specifically, the HIE 102 authenticates itself to the MDI Portal 100 via an authentication certificate or token 118. For example, in one embodiment, the authentication certificate 118 requires three points of client identification, such as the patient's name, date of birth, and hospital identification number. In other embodiments, the authentication certificate 118 may require other information relating to one or more identifiers of the patient.

After the HIE 102 has been authenticated, the HIE 102 communicates with the MDI Portal 100 to exchange patient and device data 120. The communication between the HIE 102 and the MDI Portal 100 are based upon Implantable Device Cardiac Observation (IDCO) Profile requirements. For example, in the illustrated example, the HIE 102 communicates the Patient Identifier Cross-Reference (PIX) and Patient Demographic Query (PDQ) profiles 120 to the MDI Portal 100. In one embodiment, the data includes device information and the medical device product code (MRN).

The MDI Portal 100 processes the patient and device data and determines the pertinent device and Device Vendor 104. In one embodiment, the MDI Portal 100 communicates with the relevant Device Vendor 104 and the Device Vendor Dedicated Data Store 106 to determine the pertinent device and Device Vendor 104. In one example, the MDI Portal 100 queries the Device Vendor 104 and the Device Vendor Dedicated Data Store 106 with the patient and device data received from the HIE 102, e.g., particular device, and receives responsive Device Vendor 104 Data. Further, the MDI Portal 100 may also retrieve relevant information from the Device Registry and any recent Interrogation Data. In other embodiments, the MDI Portal 100 may query a Cardiac Rhythm Management (CRM) Database 122 for relevant information.

The MDI Portal 100 processes all of the received data and provides the HIE 102 access to the Master Patient Index (MPI) 124. Afterwards, the healthcare provider can utilize the HIE 102 or the MDI Portal 100 to view information concerning the patient, the device, and the patient's last episode. Furthermore, in alternate embodiments, the MDI Portal 100 may also communicate with certain billing departments, such as electrophysiology (EP) billing 126 for the interrogation of device data.

FIG. 3 is a schematic block diagram illustrating an example of the MDI Portal 100, shown in FIG. 1. The MDI Portal 100 includes a computing device 108 and one or more data storage devices 110. In the example embodiment, the computing device 108 and a data storage device 110 are shown as the MDI Portal 100 and the Medical Device Registry 110, respectfully.

The data storage device 110 can be a part of the computing device 108 (such as memory or secondary storage device), or can be a separate data storage device. For example, the data storage device 110 can be a separate database, which can itself include one or more computing devices 108, in some embodiments. In any event, the data storage device 110 includes one or more computer readable storage devices that store digital data.

The computing device 108 includes one or more engines that are executed by the computing device 108 to perform particular functions. In this example, the computing device 108 includes a data registry retrieval engine 128, an interrogation data engine 130, a Device Vendor communication engine 132, HIE communication engine 134 having an authentication engine 136, and a user interface engine 138.

The data registry retrieval engine 128 performs the operations necessary to query the MDI Protocol Medical Device Registry 110 for a particular patient/device and the respective Device Vendor 104. For example, in one embodiment, the MDI Portal 100 receives the PIX/PDQ communication 120 from the HIE 102 and queries the Medical Device Registry 110 using the MRN and selected patient information to determine the pertinent Device Vendor 104.

The interrogation data engine 130 performs the operations necessary to obtain and/or process data from the medical device. The interrogation data engine 130 has multiple methods of receiving data from the medical device. In one example, the healthcare professional orders the interrogation of the device to obtain current data because the previously interrogated data relates to an out-of-date episode. After the device interrogation is complete, the healthcare professional uploads the interrogation data to the MDI Portal 100 for processing. In another example, the healthcare professional uploads the device data to the MDI Portal 100 for interrogation and processing. In yet another example, the interrogation data engine determines whether the patient has a home monitoring device and utilizes the data from the home monitoring device to interrogate and/or process the data.

The Device Vendor communication engine 132 performs the operations necessary to query and receive registry and device information from the Device Vendor 104. The Device Vendor communication engine integrates 132 the vendor device registry information with the MDI Portal 100 via a HL7 demographic interface or flat file upload. For communication with the Device Vendor 104 the demographic information should include at least the device model number, device serial number, patient name, patient address, and patient date of birth. With respect to the HL7 demographic interface, in one embodiment, the Device Vendor communication engine 132 uses an ADT message to query the vendor device registry information. The Patient Identification (PID) segment of the ADT message is based upon the IDCO profile PID segment, which uses the model number and serial number of the device as the primary identifier in PID 3.1. For example, in one embodiment, the PID segment of the ADT message is arranged as MODEL:XXX/SERIAL:XXX. The Device Vendor communication engine 132 then receives relevant information from the Device Vendor 104, their Device Registry 110, and/or the Device Vendor Dedicated Data Store 106. With respect to the flat file upload, the Device Vendor 104 communication engine queries the Device Vendor 104 using the demographic information and receives a flat file upload to process. Further, the MDI Portal 100 supports both discrete and report based data received from the Device Vendor 104.

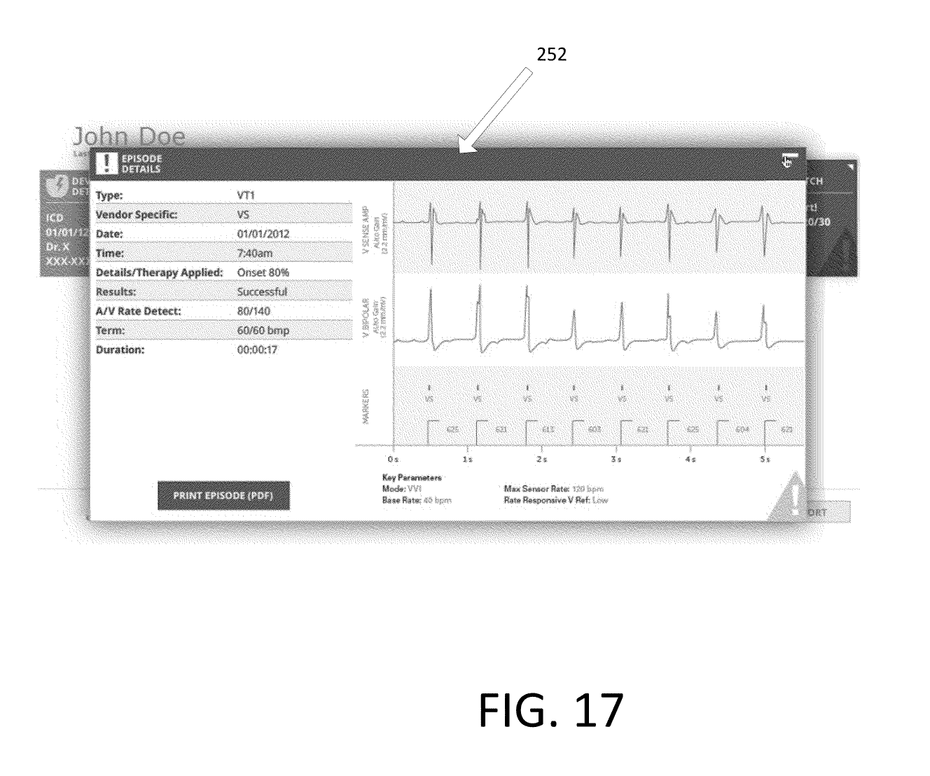

In some embodiments, the MDI Portal 100 may have additional formatting requirements for the device data. For example, as mentioned above, communication with the MDI Portal 100 is based on the IDCO Profile. In order to perform certain features of the MDI Portal 100, such as in FIG. 17, the MDI Portal 100 is configured to receive an expanded IDCO Profile that includes raw image data of tracings during patient episodes. The expanded IDCO Profile is accomplished by encoding the image data using base64 and attaching as OBX segments to the HL7 message. An exemplary table illustrating the OBX segment is provided in Table 1.

TABLE 1

| Name | Seq | DT | Len | Opt | Ex Val |
|---|---|---|---|---|---|
| Set ID - OBX | 1 | SI | 4 | R | |
| Value Type | 2 | ID | 2 | R | ED |
| Observation Identifier | 3 | CE | 478 | R | |
| Identifier | 1 | ST | 20 | R | 1875-0 |
| Text | 2 | ST | 199 | R | Cardiac Electrophysiology Report |
| Name of Coding System | 3 | ID | 20 | R | LN |
| Observation Value | 4 | ED | 99999 | RE | Encapsulated Image |
| Source Application | 1 | ST | 10 | RE | Application |
| Type of Data | 2 | ST | 10 | RE | TIF |
| Encoding | 4 | ST | 10 | RE | Base64 |
| Data | 5 | TX | * | RE | Encapsulated and Base64 encoded TIF |
| Observation Result Status | 11 | ID | 1 | R | |
| Date/Time of Observation | 14 | TS | 26 | RE | |
| Time | 1 | DTM | 24 | R | 20110105092300.0000 + 0500 |

Accordingly, the OBX can be included along with the other episode details in the HL7 message. The MDI Portal 100 processes the HL7 messages processed on receipt and the device data is made available through the MDI Portal 100.

It should be noted that the MDI Portal 100 utilizes multiple communication protocols for secure transmission of data. For example, in one embodiment, the MDI Portal 100 provides support for Secure Socket communication wherein a secure socket listener is set up to receive encrypted messages via TCP/IP. A certificate will be provided to the Device Vendor 104 for the encrypting of data and an acknowledgement message will be sent back to the Device Vendor 104 to confirm receipt and processing of the data transmission. In another embodiment, the MDI Portal 100 provides support for TCP/IP over a Virtual Private Network (VPN) wherein the MDI Portal 100 utilizes a VPN tunnel between the Device Vendor Dedicated Data Store 106 and the Device Vendor 104 for transmission of data via TCP/IP and an acknowledgement message is subsequently sent back to the Device Vendor 104 to confirm receipt and processing of the data transmission. In another embodiment, the MDI Portal 100 provides support for file-based transmission, wherein Device Vendors 104 run software on the Device Vendor Dedicated Data Store 106 at the MDI Portal 100 to download message files from the Device Vendor 104 for the MDI Portal 100 to process. In yet another embodiment, the MDI Portal 100 provides support for FTPS communication to transmit authentication information to the Device Vendor 104 and to receive data transmissions from the Device Vendor 104.

The HIE communication engine 134 and the authentication engine 136 perform the operations necessary for communication between the MDI Portal 100 and a HIE 102. In alternate embodiments, the MDI Portal 100 would include an EMR communication engine to communicate with an EMR System. In another embodiment, a computing device directly communicates the device information with the MDI Portal 100, such that a HIE communication engine 134 or an EMR communication engine are not necessary.

In one embodiment, the authentication engine 136 is configured to receive a request for an authentication certificate or token 118 and evaluate the request for patient identifiers. As previously discussed, in one embodiment, the authentication engine 136 requires three points of client identification, e.g., the patient's name, date of birth, and hospital identification number, before the HIE 102 is permitted to communicate with the MDI Portal 100. After the authentication engine 136 authenticates the HIE 102, the HIE communication engine 134 is configured to receive device and patient information from the HIE 102. As illustrated in FIG. 2, in the illustrated example, the HIE 102 transmits the Patient Identifier Cross-Reference (PIX) and Patient Demographic Query (PDQ) profiles 120 to the MDI Portal 100.

Further, the HIE 102 provides an interface for healthcare providers to upload device interrogations to the MDI Portal 100 for processing. As discussed above, when the healthcare provider orders interrogation of the device, the resulting data can be directly uploaded in the MDI Portal 100 for processing.

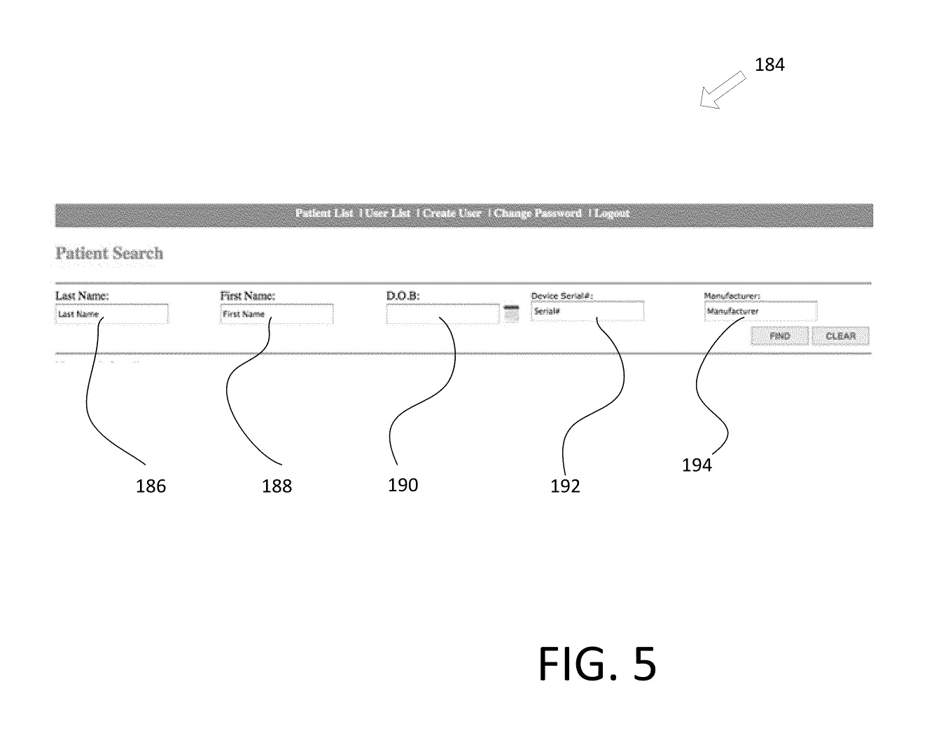

The user interface engine 138 performs the operations necessary to provide a graphical interface to display the device information to the healthcare provider. As shown in FIG. 5-17, the MDI Portal 100 provides a user-friendly platform for presentation of data obtained from device interrogation. The device data is presented in a uniform fashion irrespective of the device manufacturer. Further, the MDI Portal 100 provides easy interpretation of interrogation findings from noticeable differences between normal and abnormal findings.

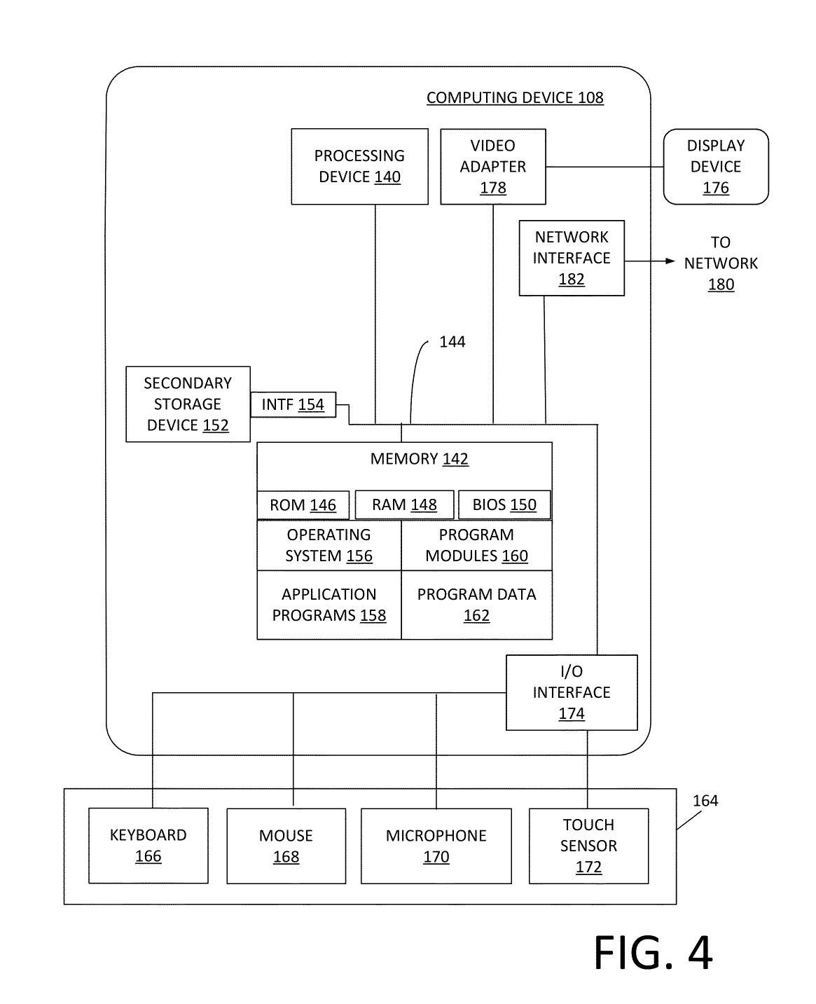

FIG. 4 illustrates an exemplary architecture of a computing device that can be used to implement aspects of the present disclosure, including any of the plurality of computing devices 102, 108, 112. The computing devices 102, 108, 112 illustrated in FIG. 1 can be used to execute the operating system, application programs, and software modules (including the software engines) described herein. By way of example, the computing device will be described below as an example of the MDI Portal 100. To avoid undue repetition, this description of the computing device 108 will not be separately repeated herein for each of the other computing devices, including 102, 112, but such devices can also be configured as illustrated and described with reference to FIG. 4.

The computing device 108 includes, in some embodiments, at least one processing device 140, such as a central processing unit (CPU). A variety of processing devices are available from a variety of manufacturers, for example, Intel or Advanced Micro Devices. In this example, the computing device 108 also includes a system memory 142, and a system bus 144 that couples various system components including the system memory 142 to the processing device 140. The system bus 144 is one of any number of types of bus structures including a memory bus, or memory controller; a peripheral bus; and a local bus using any of a variety of bus architectures.

Examples of computing devices suitable for the computing device 108 include a desktop computer, a laptop computer, a tablet computer, a mobile computing device (such as a smart phone, an iPod® or iPad® mobile digital device, or other mobile devices), or other devices configured to process digital instructions.

The system memory 142 includes read only memory 146 and random access memory 148. A basic input/output system 150 containing the basic routines that act to transfer information within computing device 108, such as during start up, is typically stored in the read only memory 146.

The computing device 108 also includes a secondary storage device 152 in some embodiments, such as a hard disk drive, for storing digital data. The secondary storage device 152 is connected to the system bus 144 by a secondary storage interface 154. The secondary storage devices 152 and their associated computer readable media provide nonvolatile storage of computer readable instructions (including application programs and program modules), data structures, and other data for the computing device 108.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media. Additionally, such computer readable storage media can include local storage or cloud-based storage.

A number of program modules can be stored in secondary storage 152 or memory 142, including an operating system 156, one or more application programs 158, other program modules 160 (such as data registry retrieval engine 128, an interrogation data engine 130, a device vendor communication engine 132, HIE communication engine 134 having an authentication engine 136, and a user interface engine 138 described herein), and program data 162. The computing device 108 can utilize any suitable operating system, such as Microsoft Windows™, Google Chrome™, Apple OS, and any other operating system suitable for a computing device. Other examples can include Microsoft, Google, or Apple operating systems, or any other suitable operating system used in tablet computing devices.

In some embodiments, a user provides inputs to the computing device 108 through one or more input devices 164. Examples of input devices 164 include a keyboard 166, mouse 168, microphone 170, and touch sensor 172 (such as a touchpad or touch sensitive display). Other embodiments include other input devices 164. The input devices are often connected to the processing device 140 through an input/output interface 174 that is coupled to the system bus 144. These input devices 164 can be connected by any number of input/output interfaces, such as a parallel port, serial port, game port, or a universal serial bus. Wireless communication between input devices 164 and the interface 174 is possible as well, and includes infrared, BLUETOOTH® wireless technology, 802.11a/b/g/n, cellular or other radio frequency communication systems in some possible embodiments.

In this example embodiment, a display device 176, such as a monitor, liquid crystal display device, projector, or touch sensitive display device, is also connected to the system bus 144 via an interface, such as a video adapter 178. In addition to the display device 176, the computing device 108 can include various other peripheral devices (not shown), such as speakers or a printer.

When used in a local area networking environment or a wide area networking environment (such as the Internet), the computing device 108 is typically connected to the network 180 through a network interface 182, such as an Ethernet interface. Other possible embodiments use other communication devices. For example, some embodiments of the computing device 108 include a modem for communicating across the network.

The computing device 108 typically includes at least some form of computer readable media. Computer readable media includes any available media that can be accessed by the computing device 108. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 108.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device 108 illustrated in FIG. 4 is also an example of programmable electronics, which may include one or more such computing devices, and when multiple computing devices are included, such computing devices can be coupled together with a suitable data communication network so as to collectively perform the various functions, methods, or operations disclosed herein.

In various alternate embodiments, the MDI Portal 100 is implemented on mobile devices such as PDAs, smartphones, or tablet computing devices. In such embodiments, the program modules or application modules on the mobile device include a local application that operates in conjunction with the MDI Portal 100 to prompt the user for input, search the database, and display results.

FIG. 5 is a screenshot of an example patient search page 184 of the MDI Portal 100 shown on the user interface. The patient search page of the MDI Portal 100 includes multiple search parameters relating to the patient, including last name 186, first name 188, date of birth 190, device serial number 192, and the manufacturer 194. The user interface engine receives one or more of the search parameters for querying the MDI Portal 100 for the relevant patient and/or device.

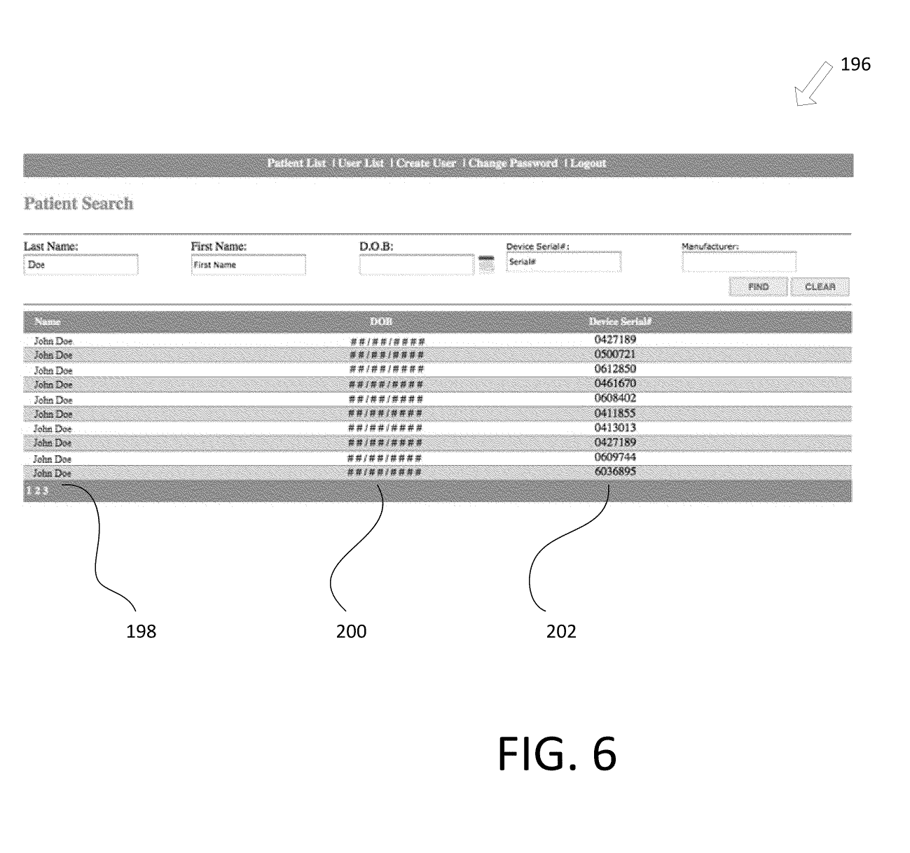

FIG. 6 is a screenshot of an example patient search results page 196 of the MDI Portal 100 shown on the user interface. As shown in the above patient search query, the user interface engine presents the results for a query for the last name “Doe.” The patient search results show all persons with the last name “Doe” 198, their date of birth 200 and the device serial number 202 for further clarification of the patient's identity.

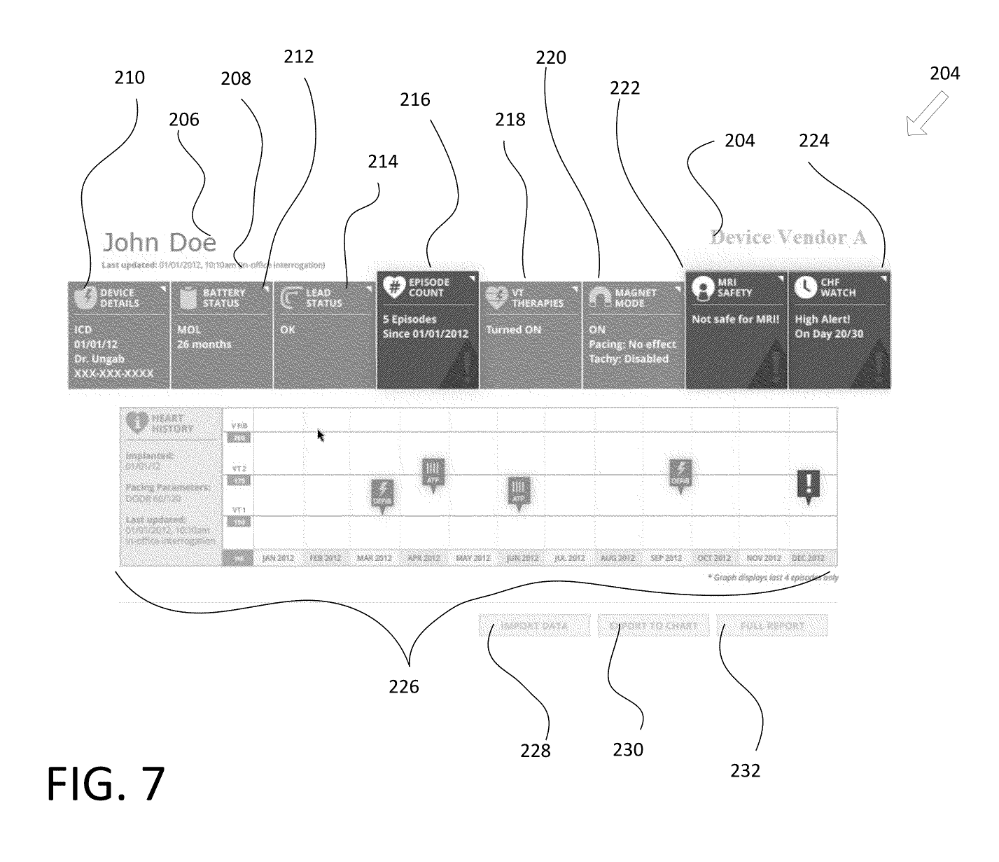

FIG. 7 is a screenshot of an example home page 204 of the MDI Portal 100 shown on the user interface. The home page of the MDI Portal 100 includes general information concerning the patient and the device, including the patent's name 206, the date of the last interrogation of the device 208, and the particular Device Vendor 104. The MDI Portal 100 further provides a plurality of tabs identifying specific categories of information concerning the operation of the device. For example, in the illustrated embodiment, the MDI Portal 100 includes categories for device details 210, battery status 212, lead status 214, episode count 216, VT therapies 218, magnet mode 220, MRI safety 222, and CHF watch 224. Further, the tabs are color coded such that issues with the device are readily apparent. For example, in the illustrated embodiment, tabs that may signify abnormal findings, which may require immediate action, are depicted in red. The tabs depicted in green indicate normal findings for the device, which do not require an immediate action. The MDI Portal 100 also includes a graphical timeline of the patient's heart history 226 including the last five occasions of episodes.

The MDI Portal 100 further includes an Import Data button 228 for importing data from a device interrogation. For example, if an ED physician orders the interrogation of a device, the resulting device data can be uploaded by the ED physician into the MDI Portal 100. The MDI Portal 100 also includes the ability to export the reports to a chart 230 or to provide a full report 232 of the episodes.

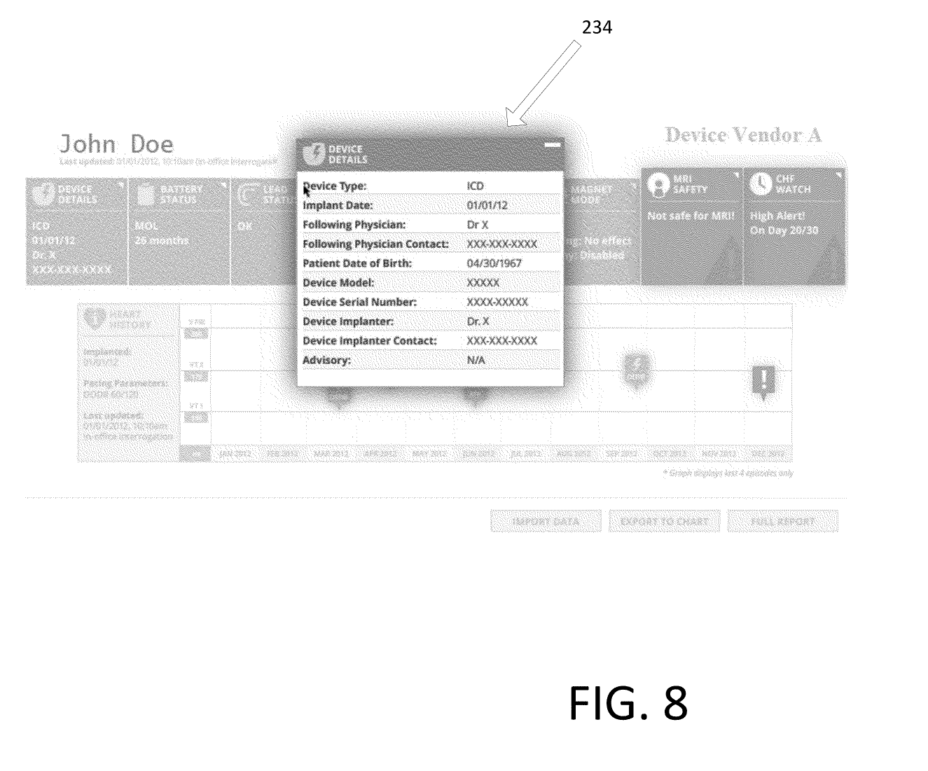

FIG. 8 is a screenshot of an example page of the MDI Portal 100 shown on the user interface. Specifically, the MDI Portal 100 is showing the relevant information on the device details tab. In the illustrated embodiment, the device details window 234 shows the device type, the implant date, the physician, the physician's contact information, the patients date of birth, the device model, the device serial number, the device implanter, the device implanter contact number, and any advisories. This allows treating physicians to quickly identify pertinent information concerning the device and the patient's regular physician.

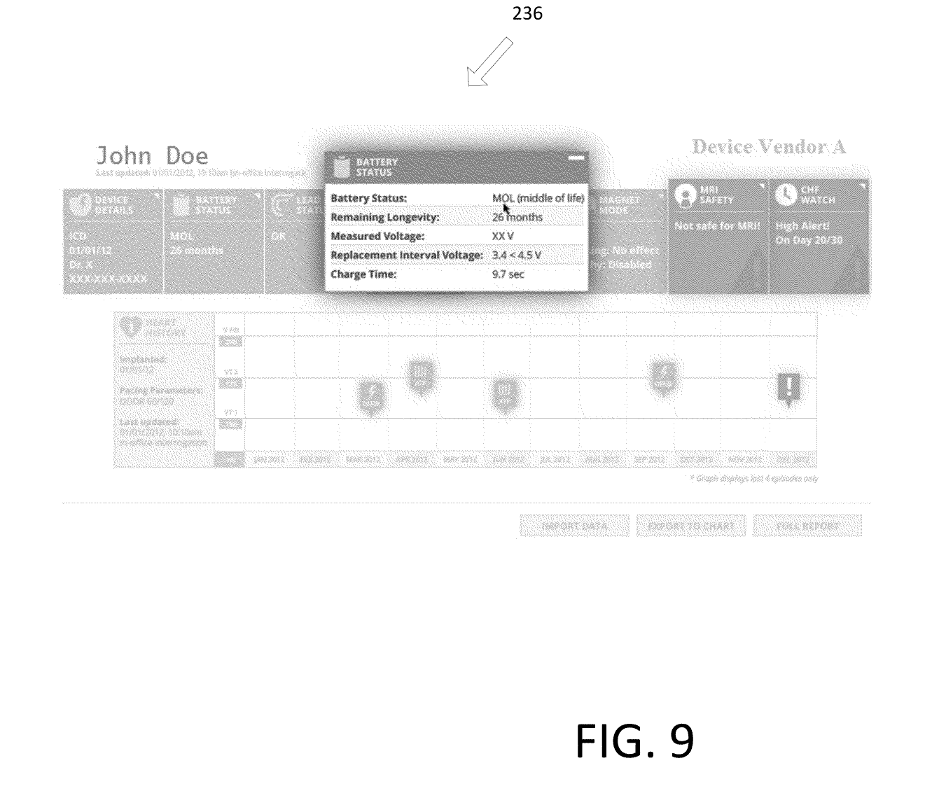

FIG. 9 is a screenshot of an example page of the MDI Portal 100 shown on the user interface. Specifically, the MDI Portal 100 is showing the relevant information on the battery status tab. In the illustrated embodiment, the battery status window 236 shows the battery status, the remaining longevity, the measured voltage, the replacement internal voltage, and the charge time.

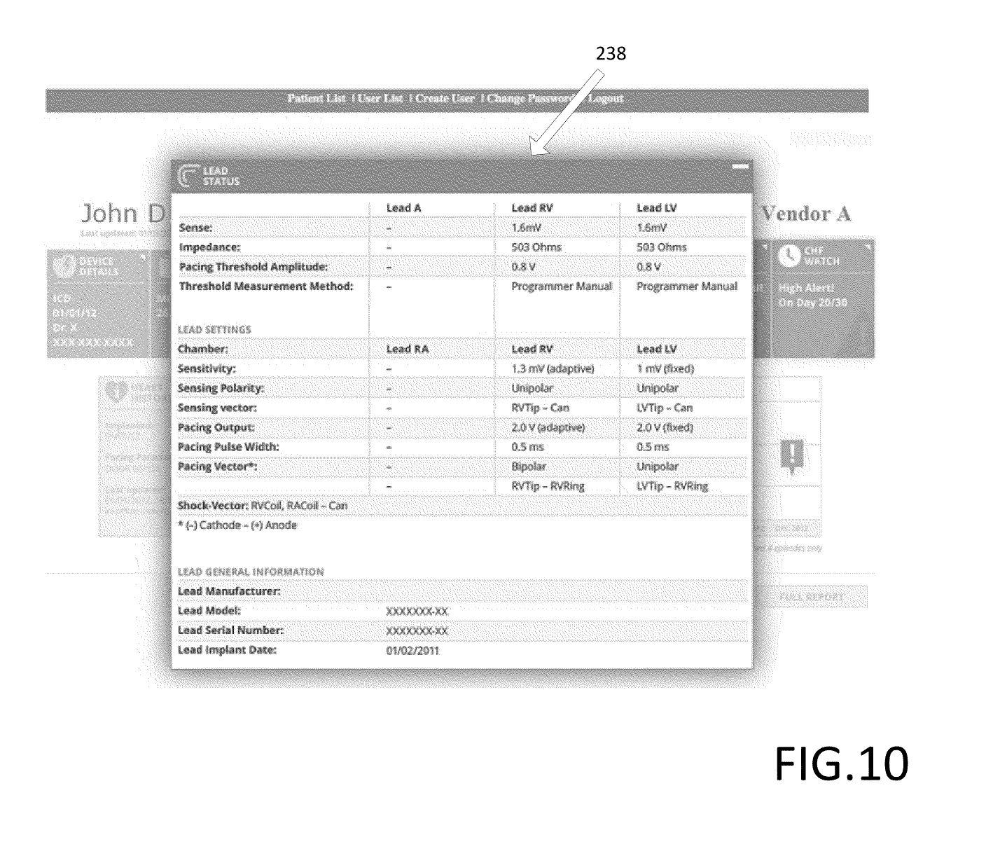

FIG. 10 is a screenshot of an example page of the MDI Portal 100 shown on the user interface. Specifically, the MDI Portal 100 is showing the relevant information on the lead status tab. In the illustrated embodiment, the lead status window 238 shows the relevant information for Lead A, Lead RA, Lead RV, and Lead LV. For each of the leads, the MDI Portal 100 includes the sense, impedance, pacing threshold, threshold measurement method, the chamber, sensitivity, sensing polarity, sensing vector, pacing output, pacing pulse width, and pacing vector. Further, the MDI Portal 100 includes the lead manufacturer, the lead model, the lead serial number, and the lead implant date.

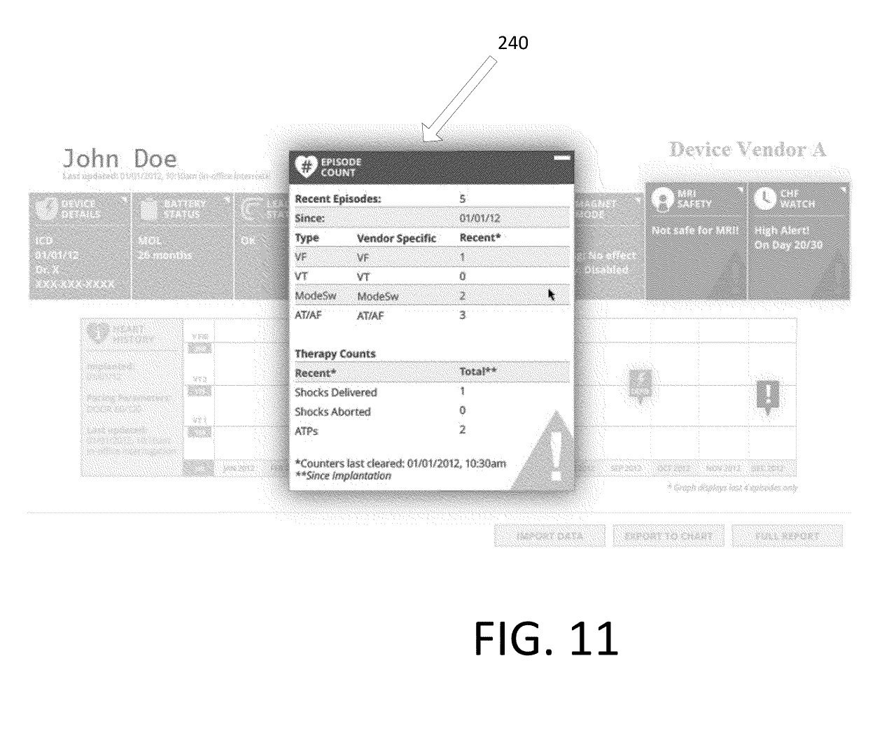

FIG. 11 is a screenshot of an example page of the MDI Portal 100 shown on the user interface. Specifically, the MDI Portal 100 is showing the relevant information on the episode count tab. In the illustrated embodiment, the Episode Count window 240 shows the relevant information for the number or recent episodes, the last beginning of the timeline of episodes, the types of episodes, the number of shocks delivered, the number of shocks aborted, and the number of ATPs.

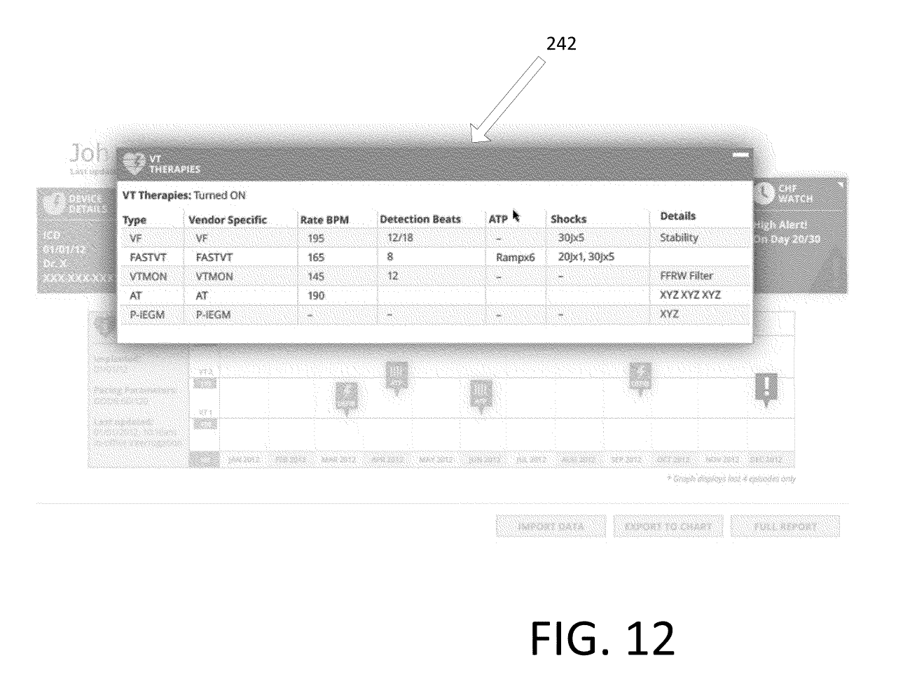

FIG. 12 is a screenshot of an example page of the MDI Portal 100 shown on the user interface. Specifically, the MDI Portal 100 is showing the relevant information on the VT Therapies tab. In the illustrated embodiment, the VT Therapies window 242 shows whether VT Therapies is off or on and the relevant information relating to the VT Therapies. It should be recognized that performing an interrogation of the device prior to surgery allows physicians to verify whether VT Therapies is turned on, which would provide physicians with a warning to turn off the VT Therapies to prevent the device from discharging during the surgery.

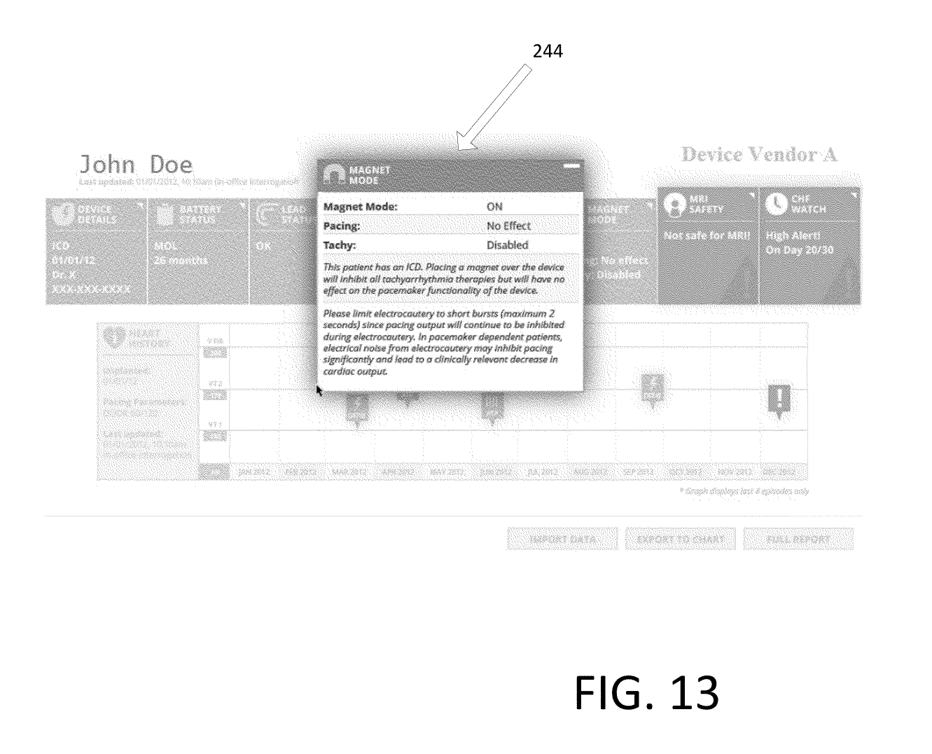

FIG. 13 is a screenshot of an example page of the MDI Portal 100 shown on the user interface. Specifically, the MDI Portal 100 is showing the relevant information on the Magnet Mode tab. In the illustrated embodiment, the Magnet Mode window 244 shows whether the magnet mode is off or on, the pacing, and the tachy.

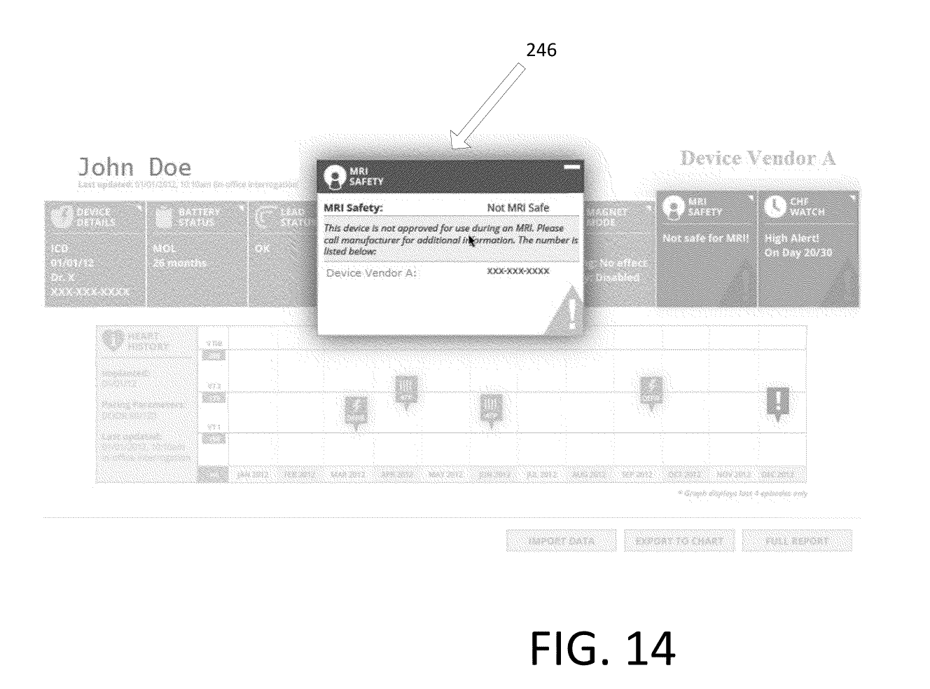

FIG. 14 is a screenshot of an example page of the MDI Portal 100 shown on the user interface. Specifically, the MDI Portal 100 is showing the relevant information on the MRI tab. In the illustrated embodiment, the MRI Safety window 246 shows whether the device is safe for MRI.

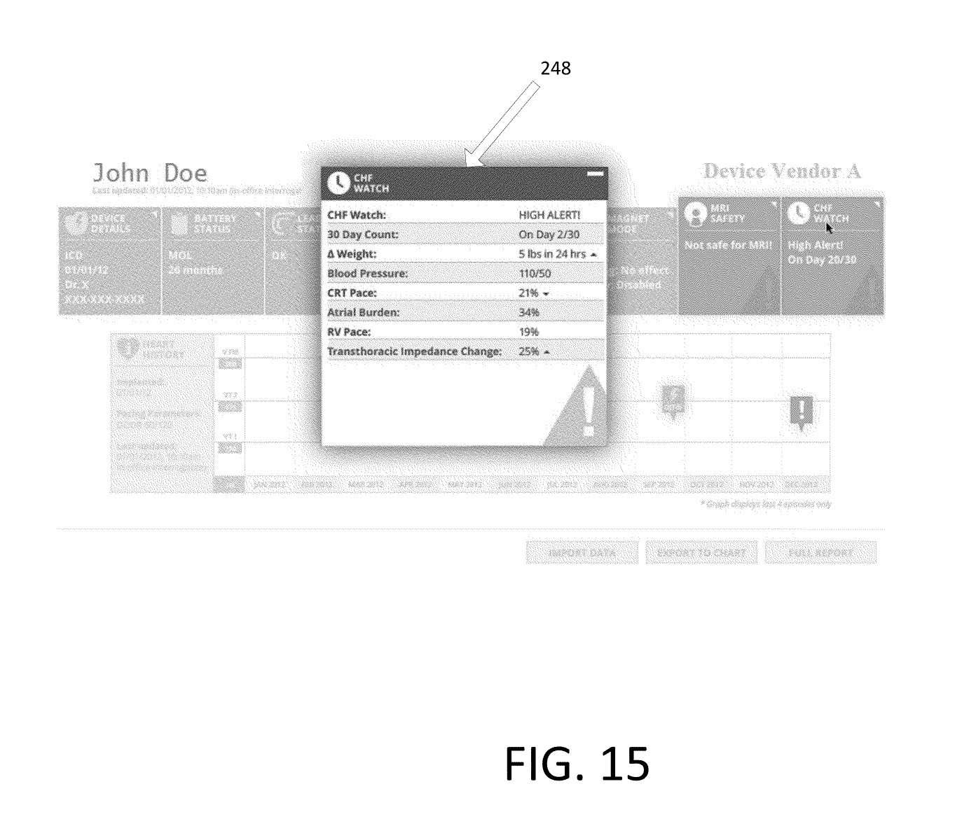

FIG. 15 is a screenshot of an example page of the MDI Portal 100 shown on the user interface. Specifically, the MDI Portal 100 is showing the relevant information on the CHF Watch tab. In the illustrated embodiment, the CHF Watch window 248 shows the status of the CHF Watch, the thirty day count, the change in weight, the patient's blood pressure, the CRT pace, Atrial burden, RV pace, and the transthoracic impedance change.

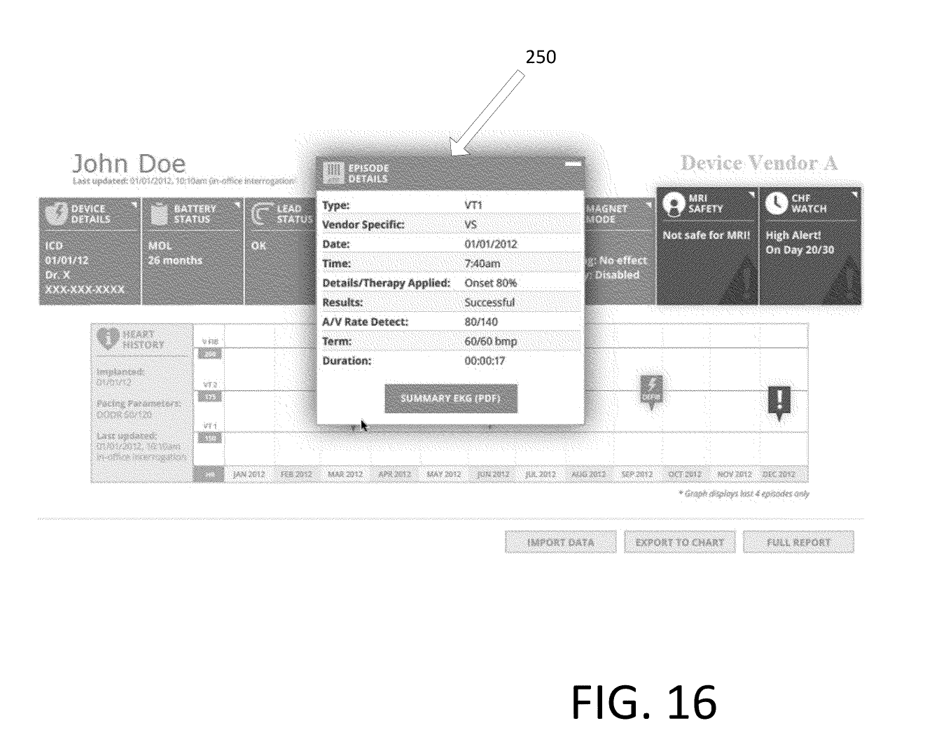

FIG. 16 is a screenshot of an example page of the MDI Portal 100 shown on the user interface. Specifically, the MDI Portal 100 is showing the Episode Details illustrated for one of the “green” episodes in the Heart History timeline. In the illustrated embodiment, the Episode Details window 250 shows the type of episode, the date of the episode, the time of the episode, the details of the therapy applied, the results, A/V rate detection, the term, and the duration.

FIG. 17 is a screenshot of an example page of the MDI Portal 100 shown on the user interface. Specifically, the MDI Portal 100 is showing the Episode Details illustrated for one of the “red” episodes in the Heart History timeline. In the illustrated embodiment, the Episode Details window 252 shows the type of episode, the date of the episode, the time of the episode, the details of the therapy applied, the results, A/V rate detection, the term, and the duration. The Episode Details window 252 further includes an electrocardiogram obtained from the raw image data of tracings during patient episodes obtained through the use of the expanded IDCO Profile.

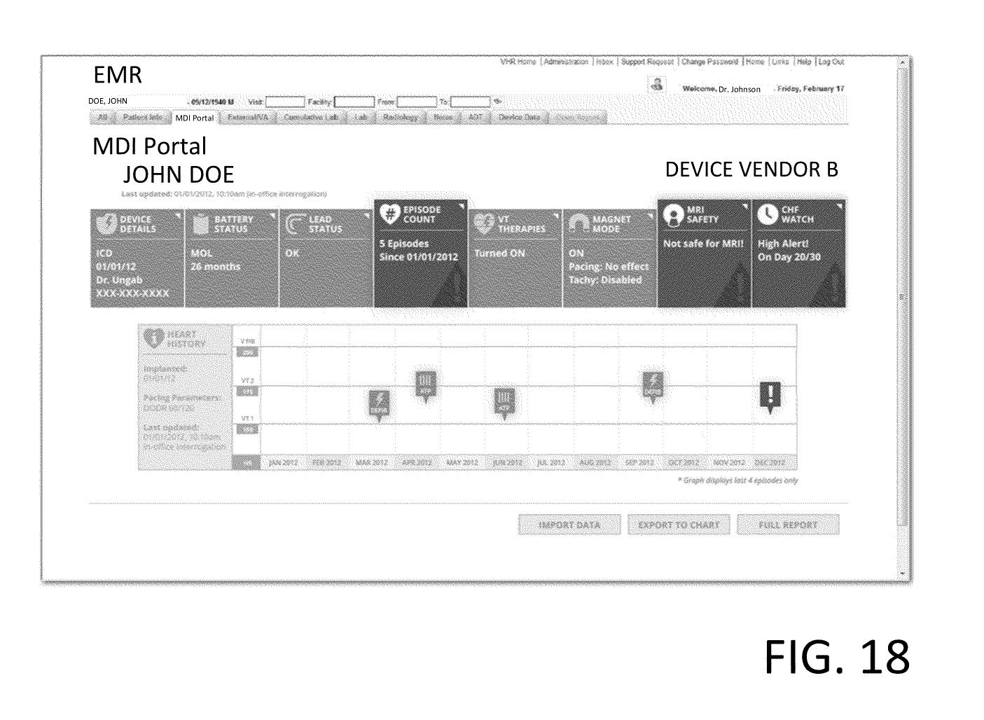

FIG. 18 is a screenshot of another example of the MDI Portal 100. In this example, the MDI Portal is part of an electronic medical records system. The electronic medical records system, in this example, includes a plurality of tabs where information can be obtained from the electronic medical records system. The exemplary tabs include all, patient info, MDI Portal 100, external/va, cumulative lab, lab, radiology, notes, adt, device data, and open report. In this example, the MDI portal tab is selected to display the MDI portal 100. The MDI Portal 100 presents medical device information through a user interface similar to or the same as the user interface pages illustrated and described herein.

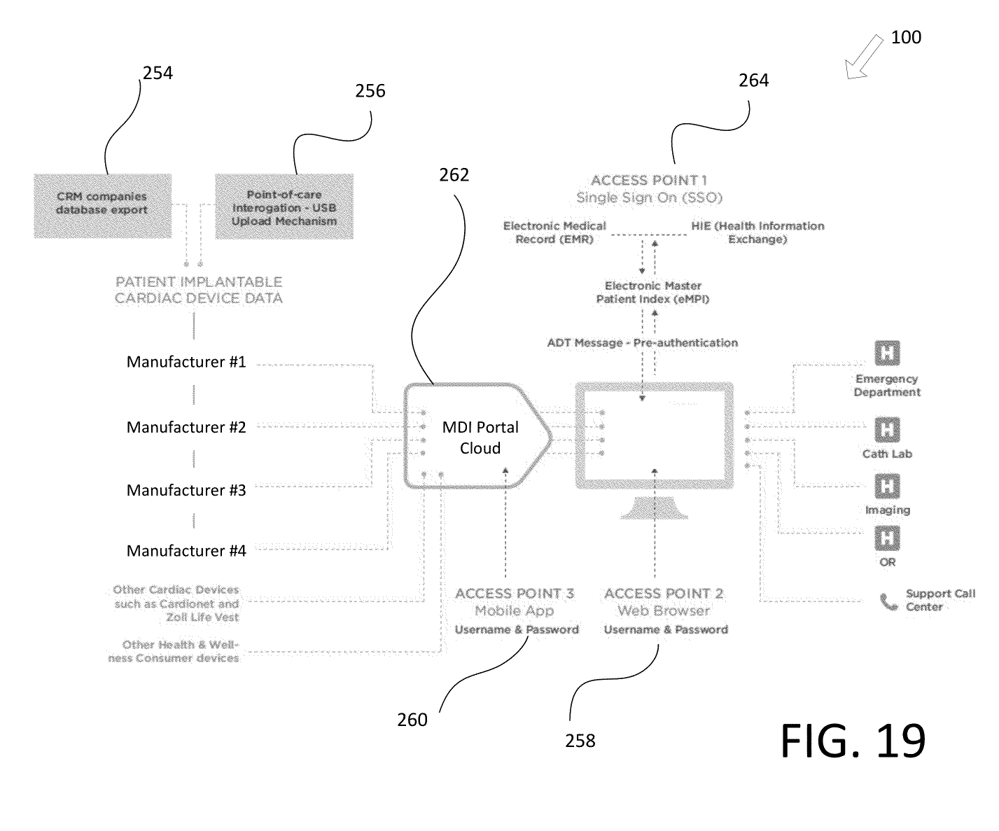

FIG. 19 is a schematic of data communications with the MDI Portal 100 via one or more access points. In the illustrated embodiment, the MDI Portal 100 obtains information relating to the implantable device from a CRM database 254 and from point-of-care interrogation 256. Although implantable devices ideally would conform to the IDCO profile standards, in reality the formatting of information relating to the implantable devices varies for each manufacturer and even for each implantable device model. Accordingly, regardless of whether the information is obtained from the CRM database 254 and from point-of-care interrogation 256, the information must be mapped such that standardized information can be provided. For example, for some CRM databases 254 the MDI Portal 100 and export raw data similar to data obtained from interrogating the implantable device. Other CRM databases 254 may only provide a PDF document containing the interrogation 256 information. In that situation, the information in the PDF must be extracted and formatted in order for the information to be utilized by the MDI Portal 100.

In other embodiments, the MDI Portal 100 obtains information from point-of-care interrogation 256. In order to receive the information the point-of-care provider are provided with an interrogator for the MDI Portal 100. The interrogator is configured for interrogating multiple types of implantable devices. Upon interrogating the implantable device, the device is configured to recognize the implantable device type and model such that the information can be properly formatted. In one embodiment, the raw data received from the interrogator is placed on a USB drive which can be uploaded to the MDI Portal 100 via a computing device.

In the illustrated embodiment, the MDI Portal 100 provides various methods of accessing the system. For example, the MDI Portal 100 is accessible via a web browser 258 that requires a user name and password. Similarly, the MDI Portal 100 is accessible by a mobile application 260 via the MDI Portal Cloud 262.

In another embodiment, the MDI Portal 100 is accessible via a single sign on (SSO) method 264. Because the point-of-care provider has access to the electronic medical records via the master patient index (MPI) for a particular patient, the point-of-care provider is provided access to the MDI Portal 100 via a link on the particular patient's electronic medical record. Specifically, access to the MDI Portal 100 is provided via a SSO connection, in some embodiments, such that the point-of-care provider can easily access the information on the MDI Portal 100 without requiring additional sign-on credentials.

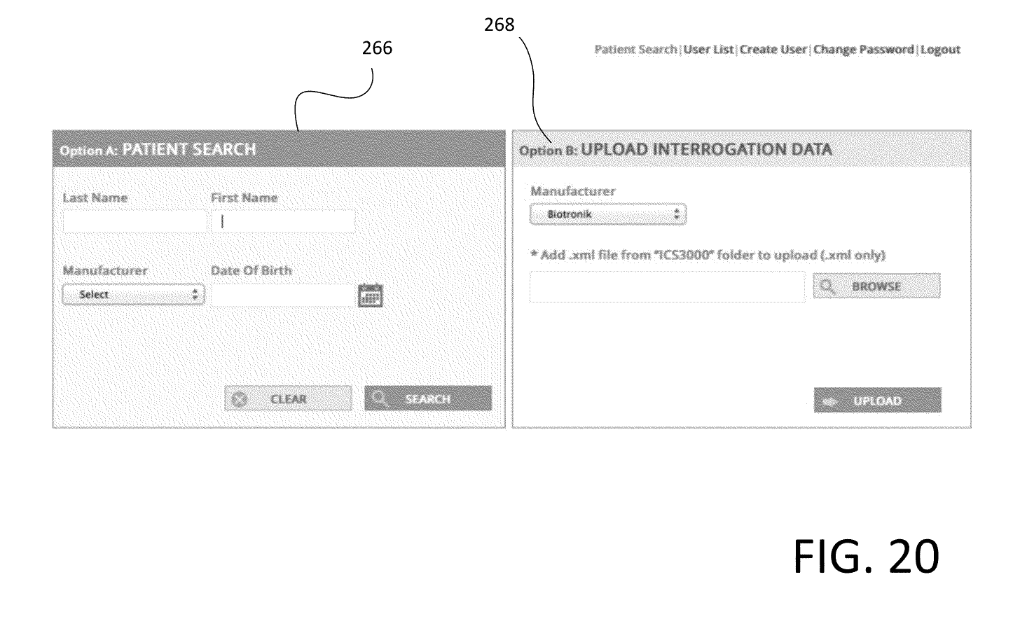

FIG. 20 is a screenshot of an example home page for a point of care provider. In the illustrated embodiment, the home page includes two options, namely a patient search option 266 and an upload interrogation data option 268. In the illustrated embodiment, the patient search option 266 includes fields for the patients name, manufacturer type, and the patient's date of birth. The MDI Portal 100 queries the MPI to match the patient with the search results. The illustrated embodiment also includes an upload interrogation data option 268, which allows interrogation data to be uploaded to the MDI Portal 100, as discussed above.

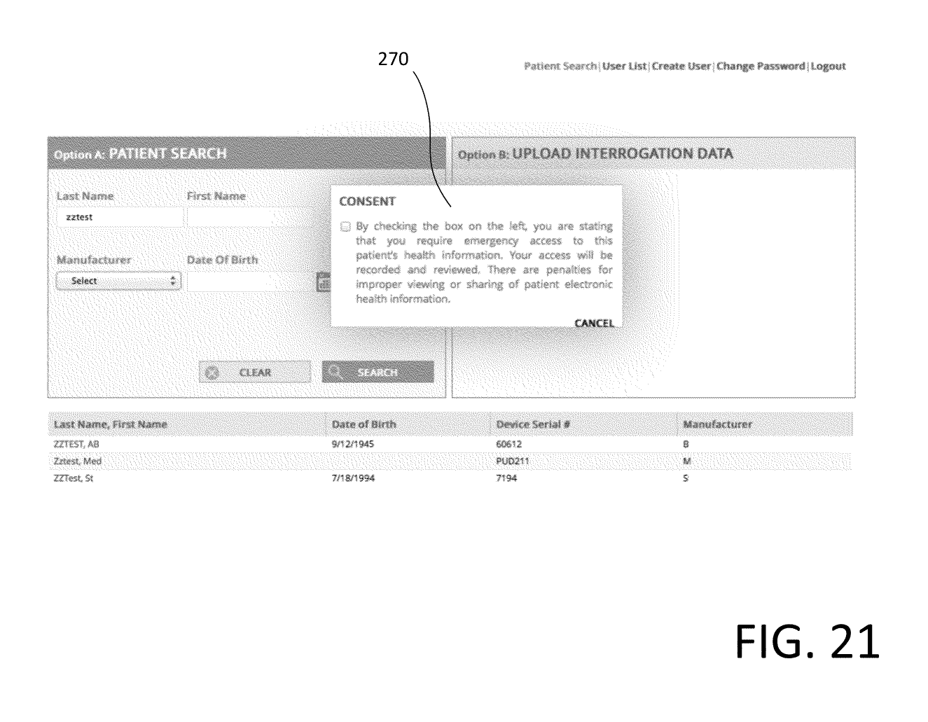

FIG. 21 is a screenshot of an example consent agreement for a point of care provider to access the MDI Portal 100. The consent agreement 270 requests that the point-of-care provider authenticate that the MDI Portal 100 is being accessed for legitimate purposes.

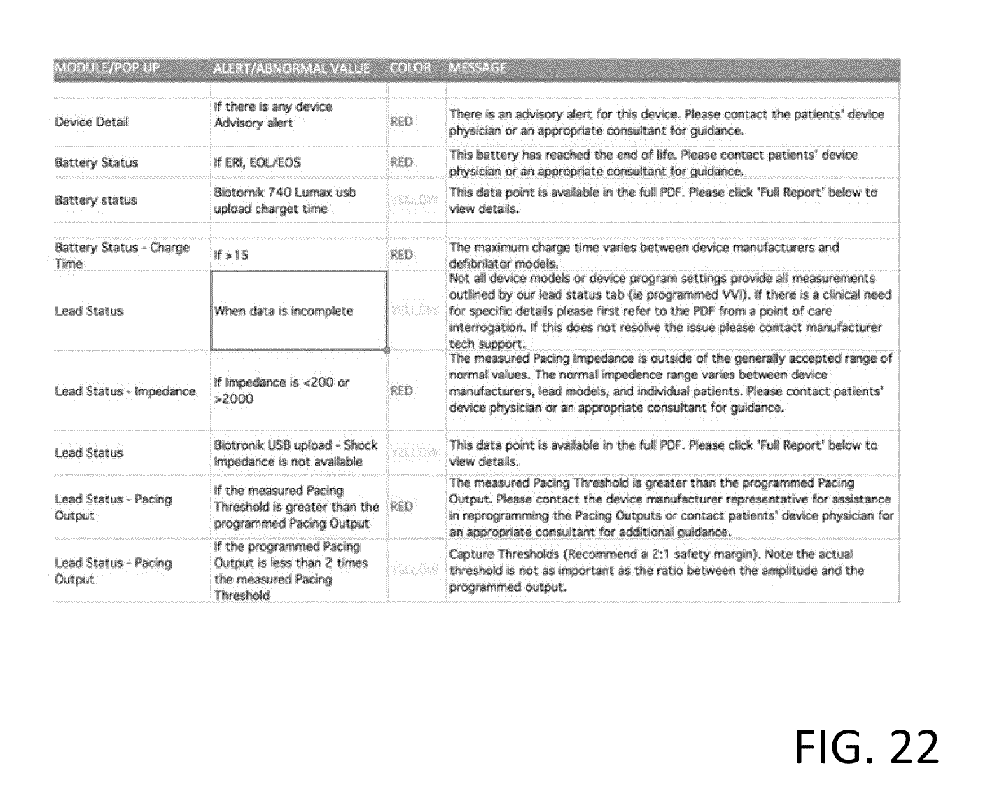

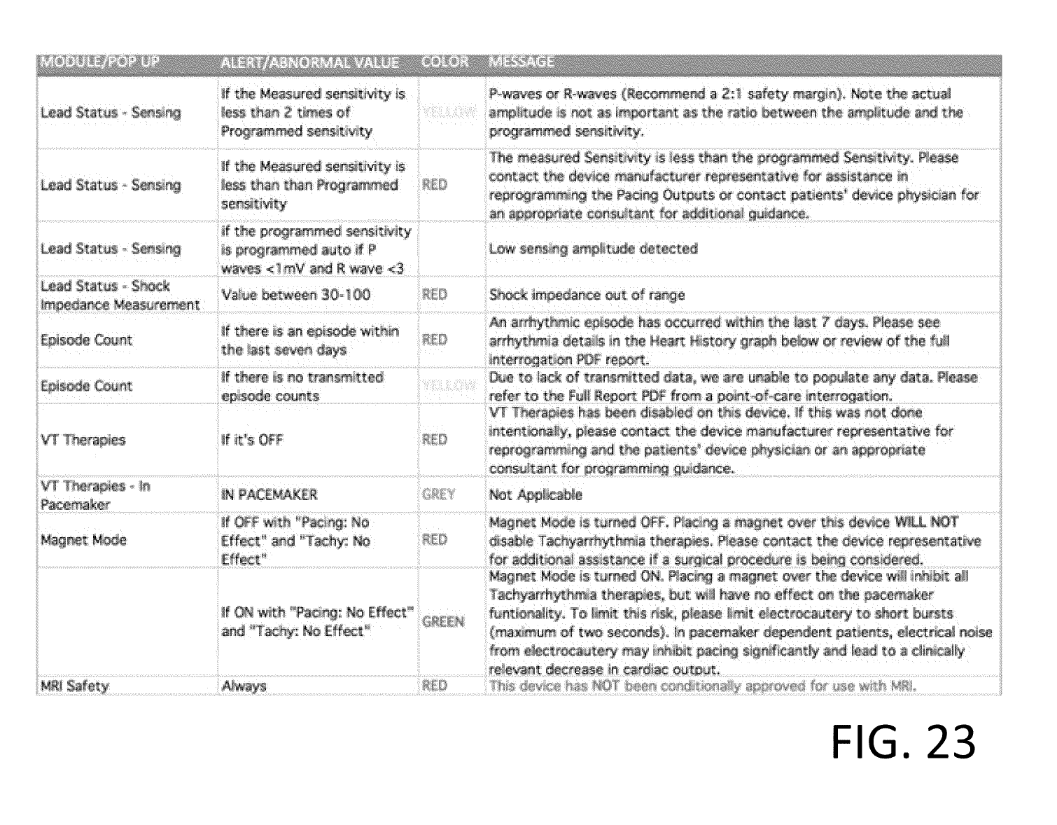

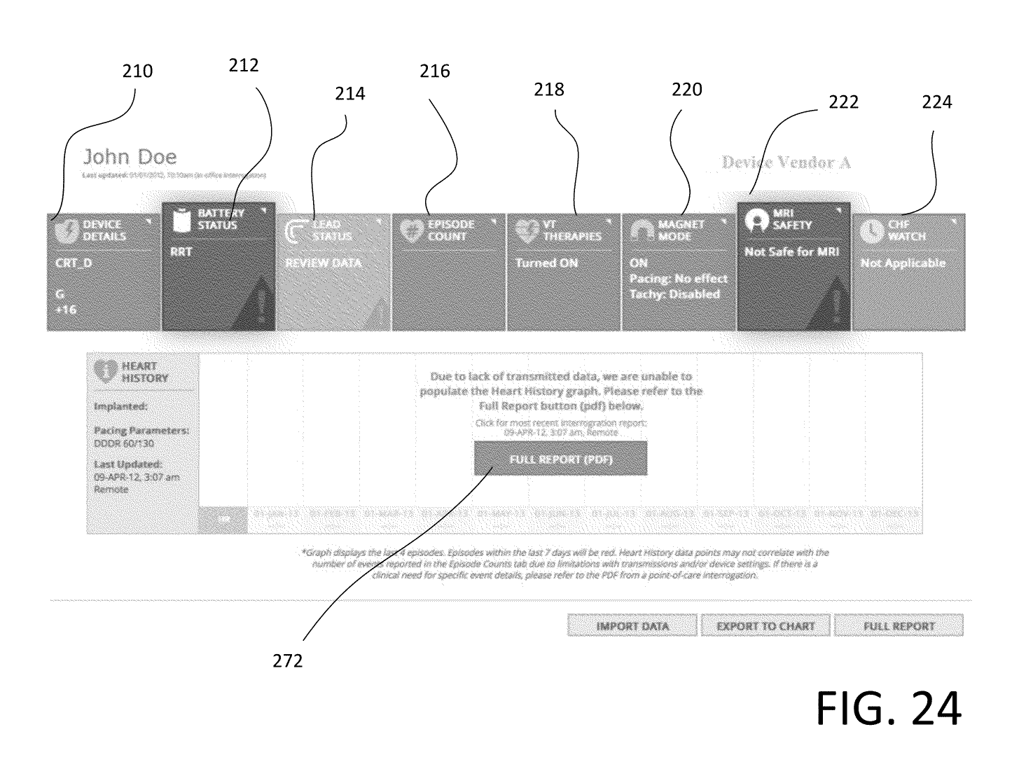

FIGS. 22 and 23 are tables illustrating example alerts for modules in the MDI Portal 100. As illustrated in the previous figures and the following figures, the interface for the MDI Portal 100 provides an interface that prominently identifies health information that needs attention. The tables include categories of information including the module/pop-up, the alert/abnormal value, the color, and a message displayed by the module/pop-up. Generally, the module/pop-up information corresponds to the category tabs displayed in the MDI Portal 100. For example, the device details module corresponds to the device details tab 210, the battery status module corresponds to the battery status tab 212, the lead status module corresponds to the lead status tab 214, the episode count module corresponds to the episode count tab 216, the VT therapies module corresponds to the VT therapies tab 218, the magnet mode module corresponds to the magnet mode tab 220, the MRI safety module corresponds to the MRI safety tab 222, and the CHF watch module corresponds to the CHF watch tab 224. Further, the table sets for an alert/abnormal value that includes a condition, which when satisfied will change the color of the respect tab displayed in the MDI Portal 100. For example, the Device Detail module sets a condition that will generate an indication when there is an advisory alert for the particular device, e.g., the device has a recall. Furthermore, the table includes a message stating “There is an advisory alert for this device. Please contact the patients' device physician or an appropriate consultant for guidance.” In another example, with respect to the battery status module, if the alert/abnormal value (if ERI, EOL/EOS) is satisfied, then the battery status tab 212, such as displayed in FIG. 24, is displayed as red and the respective alert message is generated. Similarly, with respect to the lead status module, if the alert/abnormal value (when data is incomplete) is satisfied, then the lead status tab 214, such as displayed in FIG. 24, is displayed as yellow and the respective alert message is generated. In yet another example, with respect to the MRI safety module, if the alert/abnormal value is satisfied, then the MRI safety tab 222, such as displayed in FIG. 24, is displayed as red and the respective alert message is generated.

FIG. 24 is a screenshot of an example page of the MDI Portal 100. In the illustrated embodiment, the MDI Portal 100 depicts two red indicators and a yellow indicator consistent with the tables illustrated in FIGS. 22 and 23. Furthermore, the MDI Portal 100 provides the option to download 272 the full report for the heart history graph. Specifically, in the illustrated embodiment, the MDI Portal 100 includes categories tabs for device details 210, battery status 212, lead status 214, episode count 216, VT therapies 218, magnet mode 220, MRI safety 222, and CHF watch 224. Each illustrated tab is color coded such that issues are readily apparent. For example, a green tab may indicate normal operation of the device, the yellow tab for the lead status tab 212 may identify incomplete information or general warnings relating to the operation of the device, and the red tabs for the battery status tab 212 and MRI Safety tab 222 may identify abnormal findings which may require immediate action.

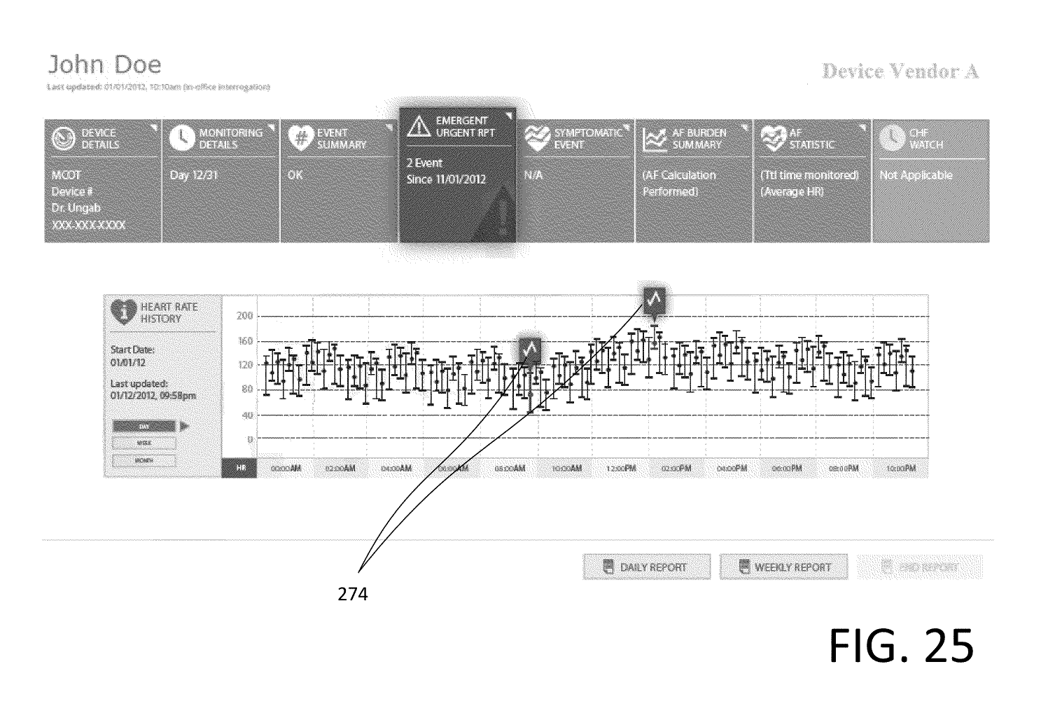

FIG. 25 is a screenshot of an example page of the MDI Portal 100. In the illustrated embodiment, when the red “Emergent Urgent RPT” is selected the MDI Portal 100 displays the Heart Rate History graph showing two indicators 274 of problematic events. Specifically, the Heart Rate History graph displays when an measurement by the implanted device obtains a measurement that satisfies the condition, such as displayed in the tables in FIGS. 22 and 23.

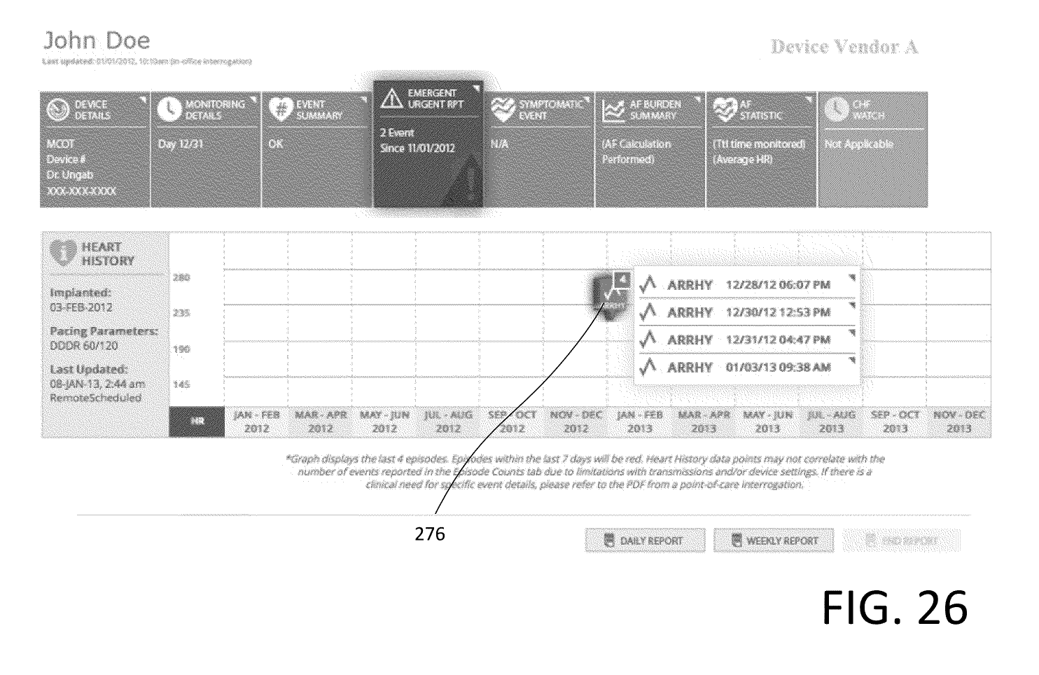

FIG. 26 is a screenshot of an example page of the MDI Portal 100. In the illustrated embodiment, when the identified events are selected, the MDI Portal 100 expands the indicator 276 to display more information about the event, such as displaying a link to each of the identified events that satisfied the condition, such as displayed in the tables in FIGS. 22 and 23. In the illustrated embodiment, the first indicator displays an indicator with a superscript 4. By selecting the indicator, the MDI Portal 100 displays the occurrence for each of the events that satisfied the condition. Further, each of the events are selectable such that additional information such as the readings, graphs, or other information is displayed for the selected event.

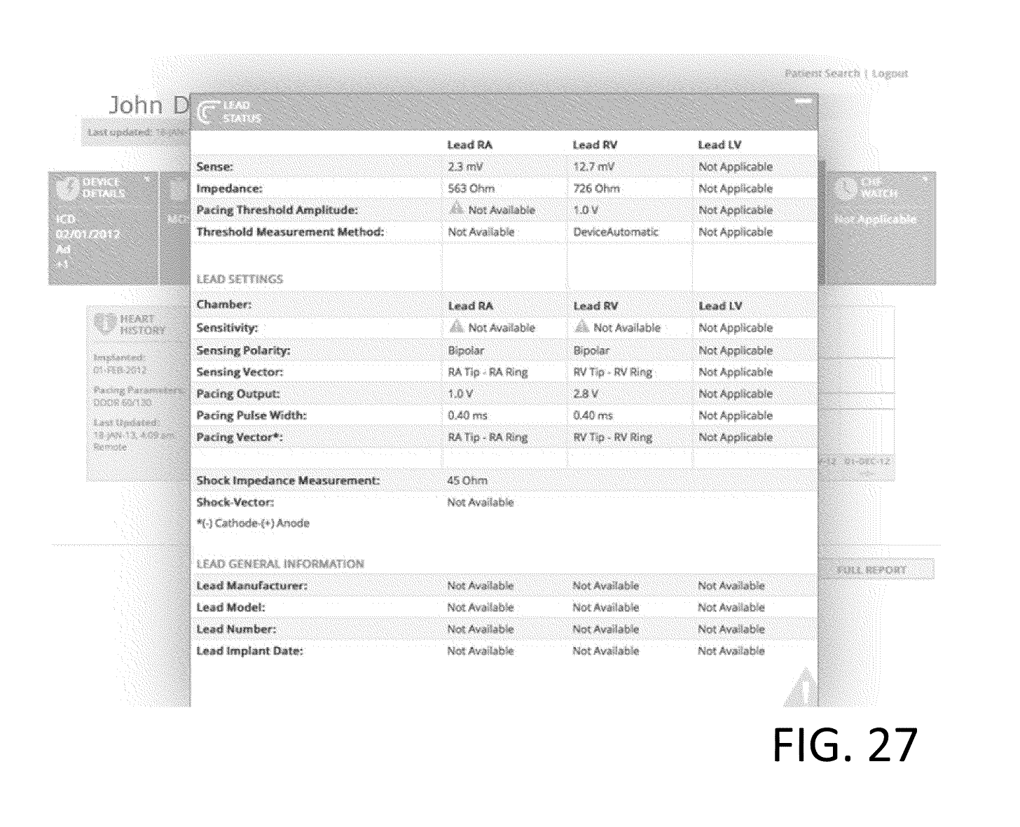

FIG. 27 is a screenshot of an example page of the MDI Portal 100. Specifically, the MDI Portal 100 is showing the relevant information on the yellow lead status tab. In the illustrated embodiment, the lead status window shows the relevant information for Lead A, Lead RA, Lead RV, and Lead LV. For each of the leads, the MDI Portal 100 includes the sense, impedance, pacing threshold, threshold measurement method, the chamber, sensitivity, sensing polarity, sensing vector, pacing output, pacing pulse width, and pacing vector. Further, the MDI Portal 100 includes the lead manufacturer, the lead model, the lead serial number, and the lead implant date.

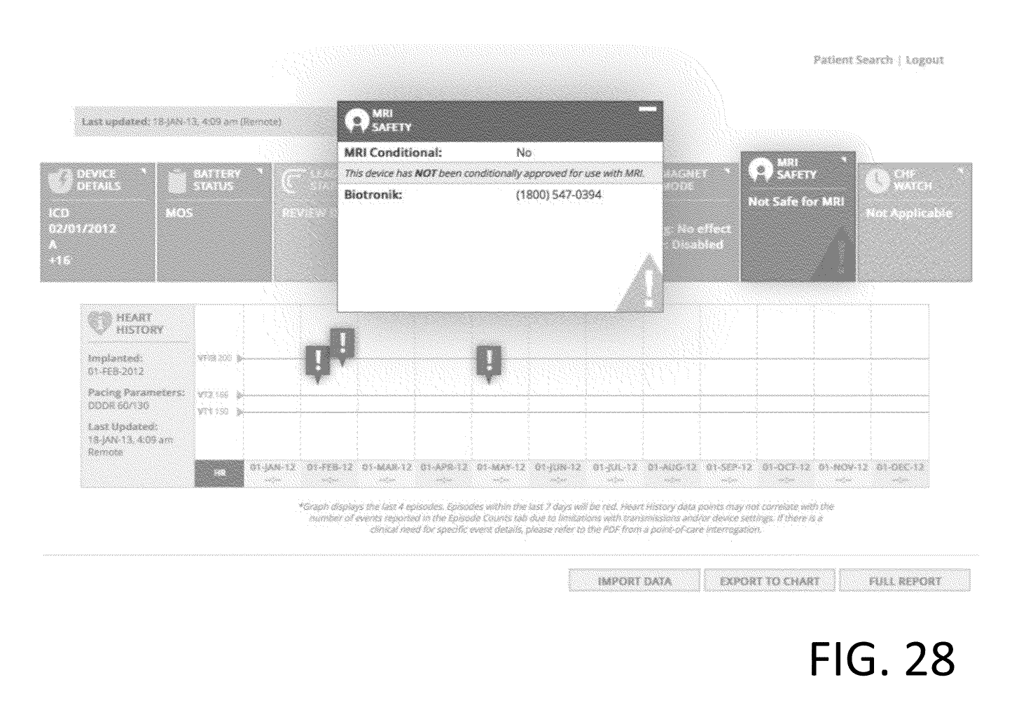

FIG. 28 is a screenshot of an example page of the MDI Portal 100. In the illustrated embodiment, the MDI Portal 100 depicts a red alert message relating to MRI safety. For the particular embodiment, the implantable device has a recall notice that alerts the point-of-care provider that the implantable device cannot be turned off. It should also be noted that other types of recall information can be displayed in the MDI Portal 100. In addition to the MDI Portal 100 can include the most up-to-date information concerning the particular implantable device, which can provide additional information to the point-of-care provider.

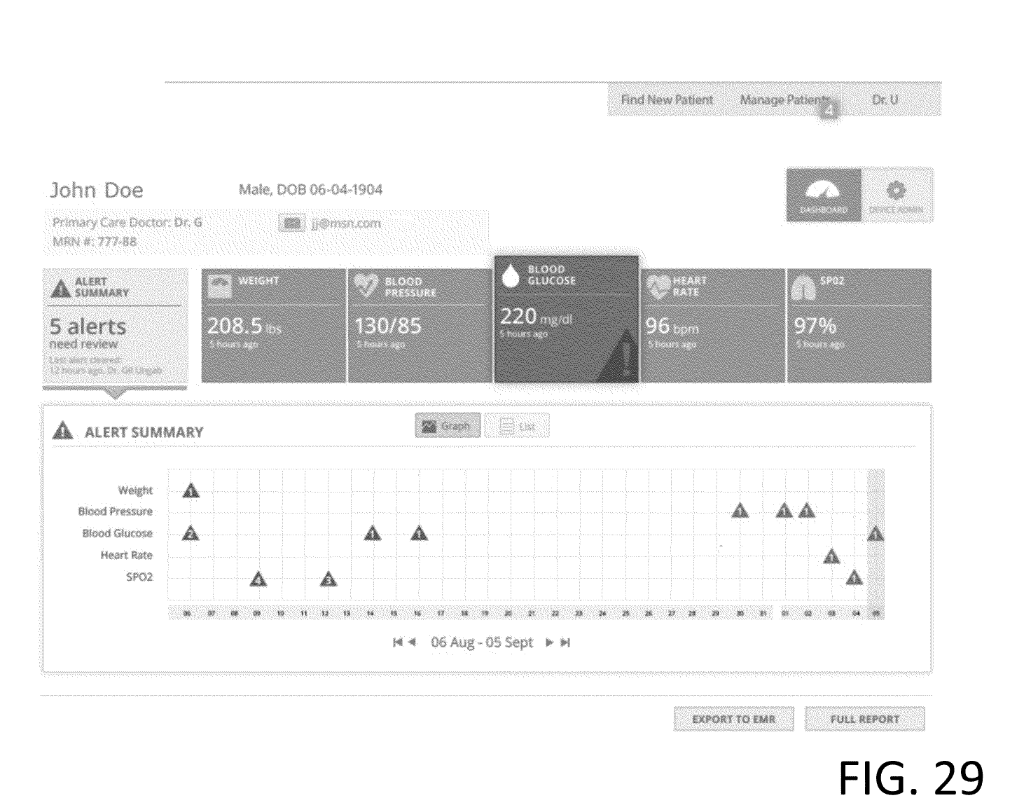

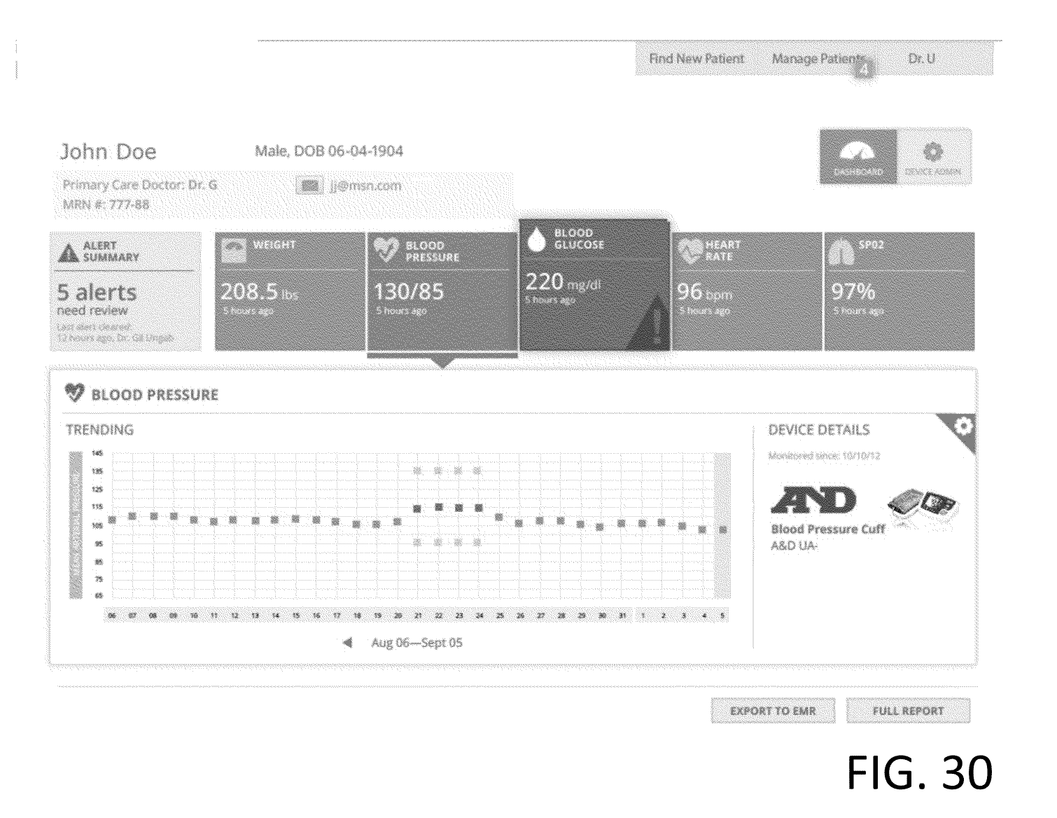

FIGS. 29 and 30 are screenshots of example pages of the MDI Portal 100. As illustrated in the figures, the information depicted in these examples relates to a non-cardiac device. Specifically, in the figures, the patients' weight, blood pressure, blood glucose, heart rate and sp02 information is tracked. As identified in FIGS. 29 and 30, the blood glucose indicator is red which identifies a current issue. Further in the Alert Summary, prior issues with blood pressure, heart rate and sp02 are visible, and displayed in a timeline. For example, in FIG. 30, the historical heart rate is displayed which allows the point-of-care provider to review trending information for the particular patient. This may allow the point-of-care provider analyze the overall health of the patient over time.

It should also be noted that other types of devices and information can be displayed in the MDI Portal 100. For example, prior to having an implantable device, patients frequently have an EKG defibrillator for several months. Similar to implantable devices, the EKG defibrillators may be interrogated for displaying relevant information in the MDI Portal 100. Additionally, information regarding the patient's medicine information may also be displayed in the MDI Portal 100.

In the foregoing description, reference is made to particular user interface displays generated by a server and displayed on a client computing device, such as through a browser software program. The user interfaces are provided as just one example of the many possible embodiments of such user interfaces, and embodiments including minor changes to such user interfaces are intended to be within the scope of this disclosure. As one example, the present disclosure makes reference to various web page controls, such as buttons, fields, selectable controls, check boxes, tabs, menus, and the like. Other embodiments can be made by selecting alternative web page controls. As another example, the present disclosure makes reference to various types of web page displays, such as windows, pages, lines, and the like. Other embodiments can be made by selecting alternative web page displays.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A medical device information portal comprising:
at least one computing device including at least one processing device; and
at least one computer readable storage device comprising data instructions, which when executed by the computing device cause the at least one computing device to generate:
an authentication engine configured to receive an authentication request from a Health Information Exchange, the authentication engine analyzes the authentication request to determine whether to allow communication with the Health Information Exchange;
a HIE communication engine to transmit and receive communication with the Health Information Exchange, the HIE communication engine is configured to receive patient and device information from the HIE relating to an implantable device, the patient and device information identifying a device vendor for the implantable device;
an interrogation data engine to receive interrogation data relating to interrogation of a medical device;
a device vendor communication engine for querying the device vendor regarding the patient and device information, the device vendor communication engine configured to receive registry and device information from the device vendor; and
a user interface engine that presents the patient and device information from the HIE communication engine, the interrogation data from the interrogation data engine, and the registry and device information from the device vendor communication engine.

2. The medical device information portal of claim 1, wherein the interrogation data engine receives interrogation data from a point-of-care provider via an upload mechanism on the user interface.

3. The medical device information portal of claim 1, wherein the interrogation data engine receives interrogation data from a database from the device vendor.

4. The medical device information portal of claim 1, wherein the user interface engine presents historical information relating to the device.

5. The medical device information portal of claim 1, wherein the user interface engine presents an indication to identify abnormal results in the interrogation data.

6. The medical device information portal of claim 1, wherein the authentication engine receive an authentication request via a single sign on request from a user authenticated to access a patient's electronic medical record.

7. A medical device information portal comprising:
at least one computing device including at least one processing device; and
at least one computer readable storage device comprising data instructions, which when executed by the computing device cause the at least one computing device to generate:
an authentication engine configured to receive an authentication request, the authentication engine analyzes the authentication request to determine whether to allow communication with the medical device information portal;
a EMR communication engine to transmit and receive communication with the EMR System, the EMR communication engine is configured to receive patient and device information from the EMR System relating to an implantable device, the patient and device information identifying a device vendor for the implantable device;
an interrogation data engine to receive interrogation data relating to interrogation of a medical device;
a device vendor communication engine for querying the device vendor regarding the patient and device information, the device vendor communication engine configured to receive registry and device information from the device vendor; and
a user interface engine that presents the patient and device information from the HIE communication engine, the interrogation data from the interrogation data engine, and the registry and device information from the device vendor communication engine.

8. The medical device information portal of claim 1, wherein the interrogation data engine receives interrogation data from a point-of-care provider via an upload mechanism on the user interface.

9. The medical device information portal of claim 1, wherein the interrogation data engine receives interrogation data from a database from the device vendor.

10. The medical device information portal of claim 1, wherein the user interface engine presents historical information relating to the device.

11. The medical device information portal of claim 1, wherein the user interface engine presents an indication to identify abnormal results in the interrogation data.

12. The medical device information portal of claim 1, wherein the authentication engine receive an authentication request via a single sign on request from a user authenticated to access a patient's electronic medical record.

13. A method of providing access to information relating to medical devices, the method comprising:
receiving medical device information associated with a first medical device;
receiving medical device information associated with a second medical device from a second different medical device manufacturer;
generating a first user interface to display the first medical device information; and
generating a second user interface to display the second medical device information, wherein the second user interface is configured in a common format as the first user interface.

14. The medical device information portal of claim 1, wherein receiving medical device information associated with a first medical device includes interrogation data uploaded from a point-of-care provider.

15. The medical device information portal of claim 1, wherein receiving medical device information associated with a first medical device includes receiving medical device information associated with a first medical device from a first medical device manufacturer.

16. The medical device information portal of claim 1, wherein receiving medical device information associated with a first medical device includes receiving interrogation data from a device manufacturer database.

17. The medical device information portal of claim 1, wherein the user interface engine presents historical information relating to the device.

18. The medical device information portal of claim 1, wherein the user interface engine presents an indication to identify abnormal results in the interrogation data.

19. The medical device information portal of claim 1, wherein the authentication engine receive an authentication request via a single sign on request from a user authenticated to access a patient's electronic medical record.
